(19) United States
(12) Patent Application Publication
(10) Pub. No.: US 2016/0047303 A1
(43) Pub. Date: Feb. 18, 2016

(54) POWER TRAIN ARCHITECTURES WITH MONO-TYPE LOW-LOSS BEARINGS AND LOW-DENSITY MATERIALS

(71) Applicant: General Electric Company, Schenectady, NY (US)

(72) Inventors: Dwight Eric Davidson, Greer, SC (US); Jeffrey John Butkiewicz, Greenville, SC (US); Jeremy Daniel Van Dam, West Coxsackie, NY (US); Thomas Edward Wickert, Greenville, SC (US)

(21) Appl. No.: 14/460,576

(22) Filed: Aug. 15, 2014

(51) Int. Cl. F02C 3/073; F02C 7/06; F02C 3/10

(52) U.S. Cl. CPC F02C 3/073; F02C 3/10; F02C 7/06

(57) ABSTRACT

Power train architectures with mono-type low-loss bearings and low-density materials are disclosed. The gas turbine used in these architectures can include a compressor section, a turbine section, and a combustor section. A generator, coupled to the rotor shaft, is driven by the turbine section. The compressor section, the turbine section, and the generator include rotating components, at least one of the rotating components in one of the compressor section, the turbine section, and the generator including a low-density material. Bearings support the rotor shaft within the compressor section, the turbine section and the generator, wherein at least one of the bearings is a mono-type low-loss bearing.

### CROSS REFERENCE TO RELATED APPLICATIONS

This patent application relates to the following commonly-assigned patent applications: U.S. patent application Ser. No. ______, entitled “POWER GENERATION ARCHITECTURES WITH HYBRID-TYPE LOW-LOSS BEARINGS AND LOW-DENSITY MATERIALS”, Attorney Docket No. 267305-1 (GEEN-480); U.S. patent application Ser. No. ______, entitled “MECHANICAL DRIVE ARCHITECTURES WITH MONO-TYPE LOW-LOSS BEARINGS AND LOW-DENSITY MATERIALS”, Attorney Docket No. 271508-1 (GEEN-0539); U.S. patent application Ser. No. ______, entitled “MECHANICAL DRIVE ARCHITECTURES WITH HYBRID-TYPE LOW-LOSS BEARINGS AND LOW-DENSITY MATERIALS”, Attorney Docket No. 271509-1 (GEEN-0540); U.S. patent application Ser. No. ______, entitled “MULTI-STAGE AXIAL COMPRESSOR ARRANGEMENT”, Attorney Docket No. 257269-1 (GEEN-0458); U.S. patent application Ser. No. ______, entitled “POWER TRAIN ARCHITECTURES WITH LOW-LOSS LUBRICANT BEARINGS AND LOW-DENSITY MATERIALS”, Attorney Docket No. 276988; and U.S. patent application Ser. No. ______, entitled “MECHANICAL DRIVE ARCHITECTURES WITH LOW-LOSS LUBRICANT BEARINGS AND LOW-DENSITY MATERIALS”, Attorney Docket No. 276989. Each patent application identified above is filed concurrently with this application and incorporated herein by reference.

### BACKGROUND

The present invention relates generally to power train architectures and, more particularly, to gas turbines, steam turbines, and generators used as part of a power train in a power generating plant with mono-type low-loss bearings and low-density materials.

In one type of a power generating plant, a gas turbine can be used in conjunction with a generator to generally form the plant's power train. In this plant, a compressor with rows of rotating blades and stationary vanes compresses air and directs it to a combustor that mixes the compressed air with fuel. In the combustor, the compressed air and fuel are burned to form combustion products (i.e., a hot air-fuel mixture), which are expanded through blades in a turbine. As a result, the blades spin or rotate about a shaft or rotor of the turbine. The spinning or rotating turbine rotor drives the generator, which converts the rotational energy into electricity.

Many gas turbine architectures deployed in such a power train of a power generating plant use slide bearings in conjunction with a high viscosity lubricant (i.e., oil) to support the rotating components of the turbine, the compressor, and the generator. Oil bearings are relatively inexpensive to purchase, but have costs associated with their accompanying oil skids (i.e., for pumps, reservoirs, accumulators, etc.). In addition, oil bearings have high maintenance interval costs and cause excessive viscous losses in the power train, which in turn can adversely affect overall output of a power generating plant.

### BRIEF DESCRIPTION OF THE INVENTION

In one aspect of the present invention, a power train architecture having a first gas turbine is disclosed. In this aspect, the first gas turbine comprises a compressor section, a turbine section, and a combustor section operatively coupled to the compressor section and the turbine section. A first rotor shaft extends through the compressor section and the turbine section of the first gas turbine. A first generator, coupled to the first rotor shaft, is driven by the turbine section of the first gas turbine. A plurality of bearings supports the first rotor shaft within the compressor section and the turbine section of the first gas turbine and the first generator, wherein at least one of the bearings is a mono-type low-loss bearing. In addition, the compressor section, the turbine section, and the generator include rotating components, at least one of the rotating components in one of the compressor section of the first gas turbine, the turbine section of the first gas turbine, and the first generator including a low-density material.

### BRIEF DESCRIPTION OF THE DRAWINGS

Features and advantages of the various embodiments of present invention will be apparent from the following more detailed description, taken in conjunction with the accompanying drawings which illustrate, by way of example, the principles of these embodiments of the present invention.

FIG. 1 is a schematic diagram of a simple cycle power train architecture including a front-end drive gas turbine, a generator, a bearing fluid skid, and further including at least one mono-type low-loss bearing and at least one rotating component made of a low-density material in use with the power train, according to an embodiment of the present invention;

FIG. 2 is a schematic diagram of a simple cycle power train architecture including a rear-end drive gas turbine, a generator, a bearing fluid skid, and further including at least one mono-type low-loss bearing and at least one rotating component made of a low-density material in use with the power train, according to an embodiment of the present invention;

FIG. 3 is a schematic diagram of a simple cycle power train architecture including a front-end drive gas turbine having a reheat section, a generator, a bearing fluid skid, and further including at least one mono-type low-loss bearing and at least one rotating component made of a low-density material in use with the power train, according to an embodiment of the present invention;

FIG. 4 is a schematic diagram of a single-shaft steam turbine and generator (STAG) power train architecture including a front-end drive gas turbine, a multi-stage steam turbine, a generator, a heat exchanger, a bearing fluid skid, and further including at least one mono-type low-loss bearing and at least one rotating component made of a low-density material in use with the power train, according to an embodiment of the present invention;

FIG. 5 is a schematic diagram of an alternate architecture of FIG. 4, which illustrates a single-shaft steam turbine and generator (STAG) power train architecture including a front-end drive gas turbine, a generator, a clutch, a multi-stage steam turbine, a heat exchanger, a bearing fluid skid, and further including at least one mono-type low-loss bearing and at least one rotating component made of a low-density material in use with the power train, according to an embodiment of the present invention;

FIG. 6 is a schematic diagram of a single-shaft steam turbine and generator (STAG) power train architecture including a rear-end drive gas turbine, a generator, a multi-stage steam turbine, a heat exchanger, a bearing fluid skid, and further including at least one mono-type low-loss bearing and at least one rotating component made of a low-density material in use with the power train, according to an embodiment of the invention;

FIG. 7 is a schematic diagram of a single-shaft steam turbine and generator (STAG) power train architecture including a front-end drive gas turbine with a reheat section, a generator, a multi-stage steam turbine, a heat exchanger, a bearing fluid skid, and further including at least one mono-type low-loss bearing and at least one rotating component made of a low-density material in use with the power train, according to an embodiment of the invention;

FIG. 8 is a schematic diagram of a two-on-one (2:1) combined cycle power train architecture including two front-end drive gas turbines (each with its own generator, heat exchanger, and bearing fluid skid) and one multi-stage steam turbine with its own generator and bearing fluid skid, and further including at least one mono-type low-loss bearing and at least one rotating component made of a low-density material in use with any one or more of the power trains, according to an embodiment of the invention;

FIG. 9 is a schematic diagram of a two-on-one (2:1) combined cycle power train architecture including two rear-end drive gas turbines (each with its own generator, heat exchanger, and bearing fluid skid) and one multi-stage steam turbine with its own generator and bearing fluid skid, and further including at least one mono-type low-loss bearing and at least one rotating component made of a low-density material in use with any one or more of the power trains, according to an embodiment of the invention;

FIG. 10 is a schematic diagram of a three-on-one (3:1) combined cycle power train architecture including three rear-end drive gas turbines (each with its own generator, heat exchanger, and bearing fluid skid) and one multi-stage steam turbine with its own generator and bearing fluid skid, and further including at least one mono-type low-loss bearing and at least one rotating component made of a low-density material in use with any one or more of the power trains, according to an embodiment of the invention;

FIG. 11 is a schematic diagram of a multi-shaft, combined cycle power train architecture including a front-end drive gas turbine coupled on a first shaft to a first generator and having a first bearing fluid skid, and a multi-stage steam turbine coupled on a second shaft to a second generator and having a second bearing fluid skid, and further including a heat exchanger, at least one mono-type low-loss bearing, and at least one rotating component made of a low-density material in use with any one or more of the power trains, according to an embodiment of the invention;

FIG. 12 is a schematic diagram of a multi-shaft, combined cycle power train architecture including a rear-end drive gas turbine coupled on a first shaft to a first generator and having a first bearing fluid skid, and a multi-stage steam turbine coupled on a second shaft to a second generator and having a second bearing fluid skid, and further including a heat exchanger, at least one mono-type low-loss bearing, and at least one rotating component made of a low-density material in use with any one or more of the power trains, according to an embodiment of the invention;

FIG. 13 is a schematic diagram of a multi-shaft, combined cycle power train architecture including a front-end drive gas turbine with a reheat section coupled on a first shaft to a first generator and having a first bearing fluid skid, and a multi-stage steam turbine coupled on a second shaft to a second generator and having a second bearing fluid skid, and further including a heat exchanger, at least one mono-type low-loss bearing, and at least one rotating component made of a low-density material in use with any one or more of the power trains, according to an embodiment of the invention;

FIG. 14 is a schematic diagram of a multi-shaft gas turbine architecture including a rear-end drive power turbine and further including at least one mono-type low-loss bearing and at least one rotating component made of a low-density material in use with the power train, according to an embodiment of the present invention;

FIG. 15 is a schematic diagram of a multi-shaft gas turbine architecture including a rear-end drive power turbine and a reheat section and further including at least one mono-type low-loss bearing and at least one rotating component made of a low-density material in use with the power train, according to an embodiment of the present invention;

FIG. 16 is a schematic diagram of a single-shaft, front-end drive gas turbine architecture including a stub shaft and a speed-reduction mechanism to reduce the speed of forward stages of a compressor and further including at least one mono-type low-loss bearing and at least one rotating component made of a low-density material in use with the power train, according to an embodiment of the present invention;

FIG. 17 is a schematic diagram of a single-shaft, front-end drive gas turbine architecture with a reheat section, which includes a stub shaft and a speed-reducing mechanism to reduce the speed of the forward stages of a compressor and which further includes at least one mono-type low-loss bearing and at least one rotating component made of a low-density material in use with the power train, according an embodiment of the present invention;

FIG. 18 is a schematic diagram of a multi-shaft, rear-end drive gas turbine architecture including a rear-end drive power turbine and further including a stub shaft and a speed-reducing mechanism to reduce the speed of forward stages of a compressor, at least one mono-type low-loss bearing, and at least one rotating component made of a low-density material in use with the power train, according to an embodiment of the present invention; and

FIG. 19 is a schematic diagram of a multi-shaft, front-end drive gas turbine architecture including a low pressure compressor section coupled to a low pressure turbine section via a low-speed spool and a high pressure compressor section coupled to a high pressure turbine section via a high-speed spool, and further including at least one mono-type low-loss bearing and at least one rotating component made of a low-density material in use with the power train, and optionally including a torque-altering mechanism, according to an embodiment of the present invention.

### DETAILED DESCRIPTION OF THE INVENTION

As mentioned above, many gas turbine architectures deployed in power generating plants use slide bearings in conjunction with a high viscosity lubricant (i.e., oil) to support the rotating components of the turbine, the compressor, and the generator. Oil bearings have high maintenance interval costs and cause excessive viscous losses in the power train, which in turn can adversely affect overall output of a power generating plant. There are also costs associated with the oil skids that accompany the oil bearings.

Low-loss bearings are one alternative to the use of oil bearings. However, certain gas turbine architectures used in a power train of a power generating plant (i.e., plants with outputs of 50 megawatts (MW) or greater) are difficult applications for the use of low-loss bearings. Specifically, as gas turbine sizes increase, the supporting bearing pad area increases as a square of the rotor shaft diameter, while the weight of the power train architecture increases as a cube of the rotor shaft diameter. Therefore, to implement low-loss bearings, the increase in bearing pad area and the increase in weight should be proportionally equal. Thus, it is desirable to incorporate light-weight or low-density materials for the power train, which help promote such proportionality.

In addition to creating a power train architecture having a weight supportable by low-loss bearings, the use of lighter weight materials can also promote the ability to produce greater airflows. Heretofore, generating a higher airflow rate in such a power train has been difficult because the centrifugal loads that are placed on the rotating blades during operation of a gas turbine increase with the longer blade lengths needed to produce the desired airflow rate. For example, the rotating blades in the forward stages of a multi-stage axial compressor used in a gas turbine are larger than the rotating blades in both the mid and aft stages of the compressor. Such a configuration makes the longer, heavier rotating blades in the forward stages of an axial compressor more susceptible to being highly stressed during operation due to large centrifugal pulls induced by the rotation of the longer and heavier blades. In particular, large centrifugal pulls are experienced by the blades in the forward stages due to the high rotational speed of the rotor wheels, which, in turn, stress the blades. The large attachment stresses that can arise on the rotating blades in the forward stages of an axial compressor become problematic as it becomes more desirable to increase the size of the blades in order to produce a compressor that can generate a higher airflow rate as demanded by certain applications.

It would be desirable, therefore, to provide a power train architecture for a power generating plant, which incorporates one or more low-loss bearings used in conjunction with low-density materials, as applied in gas turbines, steam turbines, or generators. Such architectures can provide greater power output with fewer viscous losses, thereby increasing the overall efficiency of the power generating plant.

Various embodiments of the present invention are directed to providing power train architectures that have a gas turbine with mono-type low-loss bearings and low-density materials as part of a power generating plant.

As used herein, a “power train architecture” is an assembly of moving parts, which can include the rotating components of one or more of a generator, a compressor section, a turbine section, a reheat turbine section, a power turbine section, and a steam turbine, which collectively communicate with one another in the production of power. The power train architecture is a subset of the overall power plant equipment used in a power generating plant. The phrases “power train architecture” and “power train” may be used interchangeably.

As used herein, a “mono-type low-loss bearing” is a primary bearing assembly, which has a single working fluid that has a very low viscosity and which, when installed, has an accompanying secondary bearing that is a roller bearing element. The “primary bearing assembly” may be a journal bearing, a thrust bearing, or a journal bearing adjacent a thrust bearing. Examples of “very low viscosity” fluids used in the present mono-type low-loss bearings have a viscosity less than water (i.e., 1 centipoise at 20° C.) and may include, but are not limited to: air (e.g., in high pressure air bearings), gas (e.g., in high pressure gas bearings), magnetic flux (e.g., in high flux magnetic bearings), and steam (e.g., in high pressure steam bearings). In a gas bearing, the gaseous fluid may be an inert gas, hydrogen, carbon dioxide (CO₂), nitrogen dioxide (NO₂), or hydrocarbons (including methane, ethane, propane, and the like). Examples of roller bearing elements used as the secondary or back-up bearings include spherical roller bearings, conical roller bearings, tapered roller bearings, and ceramic roller bearings

As used herein, a “low-density material” is material that has a density that is less than about 0.200 lbm/in³. Examples of a low-density material that is suitable for use with rotating components (e.g., blades 130 and 135) illustrated in the Figures and described herein include, but are not limited to: composite materials, including ceramic matrix composites (CMCs), organic matrix composites (OMCs), polymer glass composites (PGCs), metal matrix composites (MMCs), carbon-carbon composites (CCs); beryllium; titanium (such as Ti-64, Ti-6222, and Ti-6246); intermetallics including titanium and aluminum (such as TiAl, TiAl₂, TiAl₃, and Ti₃Al); intermetallics including iron and aluminum (such as FeAl); intermetallics including platinum and aluminum (such as PtAl); intermetallics including cobalt and aluminum (such as CbAl); intermetallics including lithium and aluminum (such as LiAl); intermetallics including nickel and aluminum (such as NiAl); and nickel foam.

Use of the phrase “the low-density material” in the present application, including the Claims, should not be interpreted as limiting the various embodiments of the present invention to the use of a single low-density material, but rather can be interpreted as referring to components including the same or different low-density materials. For example, a first low-density material could be used in one section of an architecture while a second (different) low-density material could be used in another section.

In the Figures, the use of low-density materials is represented by a dashed line in the respective section of the power train where such low-density materials may be used. To represent the use of low-density material within the rotating components of the generator, cross-hatched shading is used. Although the Figures may illustrate the low-density materials being used in most or all of the sections of the power train architectures, it should be understood that the low-density materials may be confined to one or more sections of the power train.

In contrast to the low-density materials described above, a “high-density material” is a material that has a density that is greater than about 0.200 lbm/in³. Examples of a high-density material (as used herein) include, but are not limited to: nickel-based superalloys (such as alloys in single-crystal, equi-axed, or directionally-solidified form, examples of which include INCONEL® 625, INCONEL® 706, and INCONEL® 718); steel-based superalloys (such as wrought CrMoV and its derivatives, GTD-450, GTD-403 Cb, and GTD-403 Cb+); and all stainless steel derivatives (such as 17-4PH® stainless steel, AISI type 410 stainless steel, and the like).

The technical effects of having power train architectures with mono-type low-loss bearings and low-density materials as described herein are that these architectures: (a) provide the ability to use low-loss bearings in a power train that would otherwise be too heavy to operate; (b) allow the reconfiguration of the oil skid conventionally used to supply the oil bearings in the power train; and (c) deliver a high output load while overcoming viscous losses that are typically introduced into the power train through the use of oil-based bearings.

Delivering a larger quantity of airflow by using rotating blades in the gas turbine that include low-density materials translates to a higher output of the gas turbine. As a result, gas turbine manufacturers can increase the size of the rotating blades to generate higher airflow rates, while at the same time ensuring that such longer blades keep within the prescribed inlet annulus (AN²) limits to obviate excessive attachment stresses on the blades, even when the blades are made from low-density materials. Note that AN² is the product of the annulus area A (in²) and rotational speed N squared (rpm²) of a rotating blade, and is used as a parameter that generally quantifies power output rating from a gas turbine.

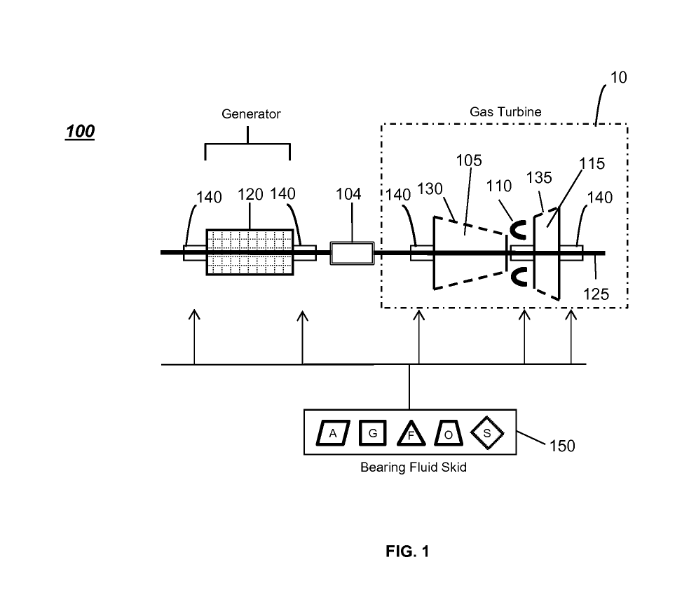

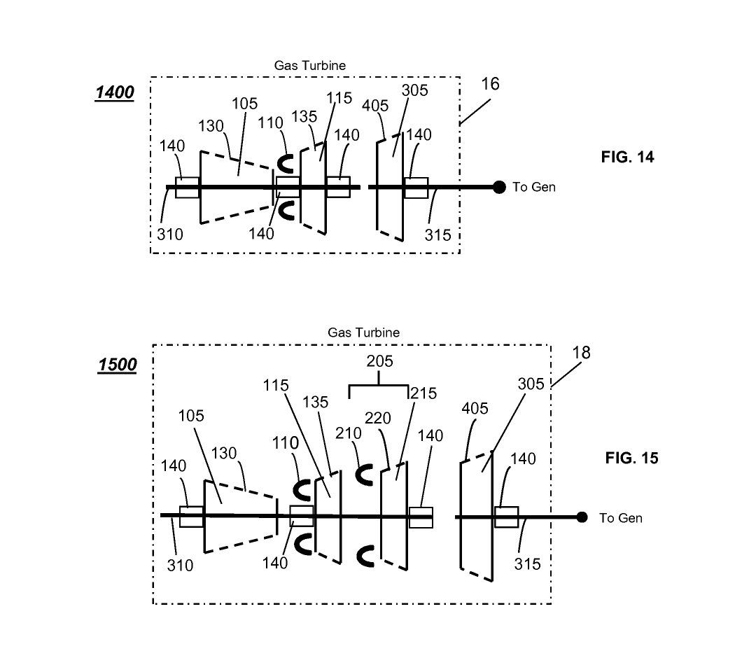

FIGS. 1 through 13 illustrate various power train architectures including gas turbines, steam turbines, and/or generators, which may include multiple bearing locations. FIGS. 14 through 19 illustrate various gas turbine architectures, which may include multiple bearing locations. Low-loss bearings 140 may be used in any location throughout the power train, as desired, regardless of the power output of the power generating architecture. In power train architectures producing 50 MW or more of electricity, it may be advisable to use low-density materials in conjunction with low-loss bearings, since the larger component size and associated increases in weight with high-power generating plants may require the use of low-density materials. In power train architectures producing outputs of less than 50 MW (i.e., smaller power trains), it is contemplated that low-loss bearings may be used without low-density materials in the rotating components, although improved performance and/or operation may be achieved by using low-density materials for at least some of the rotating components.

In those cases where low-loss bearings are used to support a particular section of the power train architecture, low-density materials may be used in the particular rotating components of that section of the power train. For example, if the low-loss bearings are supporting a compressor section, low-density materials can be used in one or more of the stages of rotating blades within the compressor section (as indicated by dashed lines). Similarly, if the low-loss bearings are supporting a generator, low-density materials can be used in the rotating components of the generator (as indicated by cross-hatching).

The term “rotating component” is intended to include one or more of the moving parts of a compressor section, a turbine section, a reheat turbine section, a power turbine section, a steam turbine, and a generator, such as blades (also referred to as airfoils), coverplates, spacers, seals, shrouds, heat shields, and any combinations of these or other moving parts. For convenience herein, the rotating blades of the compressor and the turbine will be referenced most often as being made of a low-density material. However, it should be understood that other components of low-density material may be used in addition to, or instead of, the rotating blades.

Although the descriptions that follow with respect to the illustrated power train architectures are for use in a commercial or industrial power generating plant, the various embodiments of the present invention are not meant to be limited solely to such applications. Instead, the concepts of using mono-type low-loss bearings and rotating components of low-density material are applicable to all types of combustion turbine or rotary engines, including, but not limited to, a stand-alone compressor such as a multi-stage axial compressor arrangement, aircraft engines, marine power drives, and the like.

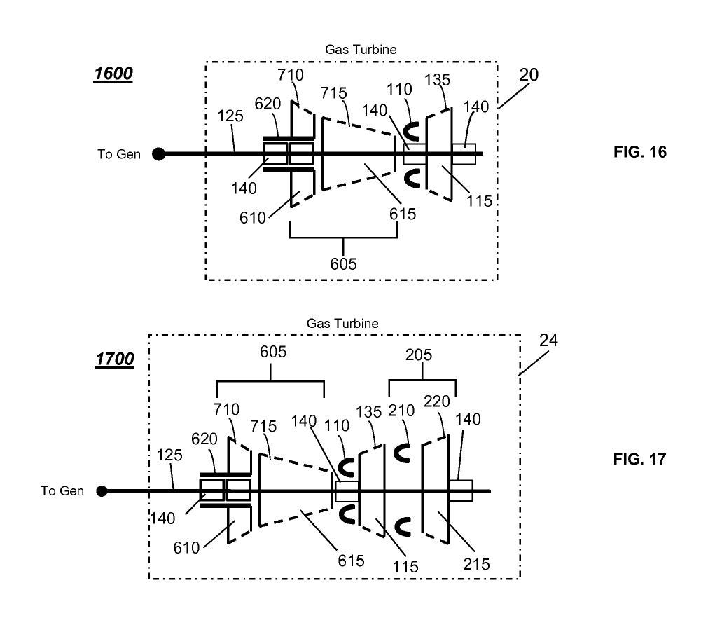

Referring now to the Figures, FIG. 1 is a schematic diagram of a single-shaft, simple cycle power train architecture 100 with a gas turbine 10 and a generator 120. At least one mono-type low-loss bearing and at least one rotating component made of a low-density material are used with the power train of the gas turbine, according to an embodiment of the present invention. As shown in FIG. 1, the gas turbine 10 comprises a compressor section 105, a combustor section 110, and a turbine section 115. The gas turbine 10 is in a front-end arrangement with generator 120 such that the generator is located proximate the compressor section 105. Other architectures for the gas turbine 10 may be used, many of which are illustrated in the following Figures, including FIGS. 16, 17, and 19.

FIG. 1 and FIGS. 2-19 do not illustrate all of the connections and configurations of the compressor section 105, the combustor section 110, and the turbine section 115. However, these connections and configurations may be made pursuant to conventional technology. For example, the compressor section 105 can include an air intake line that provides inlet air to the compressor. A first conduit may connect the compressor section 105 to the combustor section 110 and may direct the air that is compressed by the compressor section 105 into the combustor section 110. The combustor section 110 combusts the supply of compressed air with a fuel provided from a fuel gas supply in a known manner to produce the working fluid.

A second conduit can conduct the working fluid away from the combustor section 110 and direct it to the turbine section 115, where the working fluid is used to drive the turbine section 115. In particular, the working fluid expands in the turbine section 115, causing the rotating blades 135 of the turbine 115 to rotate about the rotor shaft 125. The rotation of the blades 135 causes the rotor shaft 125 to rotate. In this manner, the mechanical energy associated with the rotating rotor shaft 125 may be used to drive the rotating blades 130 of the compressor section 105 to rotate about the rotor shaft 125. The rotation of the rotating blades 130 of the compressor section 105 causes it to supply the compressed air to the combustor section 110 for combustion. The rotation of the rotor shaft 125, in turn, causes coils of the generator 120 to generate electric power and produce electricity.

A common rotatable shaft, referred to as rotor shaft 125, couples the compressor section 105, the turbine section 115 and the generator 120 along a single line, such that the turbine section 115 drives the compressor section 105 and the generator 120. As shown in FIG. 1, the rotor shaft 125 extends through the turbine section 115, the compressor section 105, and the generator 120. In this single-shaft arrangement, the rotor shaft 125 can have a compressor rotor shaft part, a turbine rotor shaft part, and a generator rotor shaft part coupled pursuant to conventional technology.

Coupling components can couple the turbine rotor shaft part, the compressor rotor shaft part and the generator rotor shaft part of rotor shaft 125 to operate in cooperation with bearings 140. The number of coupling components and their locations along rotor shaft 125 can vary by design and application of the power generating plant in which the gas turbine architecture operate. In some instances in the Figures, a vertical line through the shaft may be used to represent a joint between segments of the rotor shaft 125.

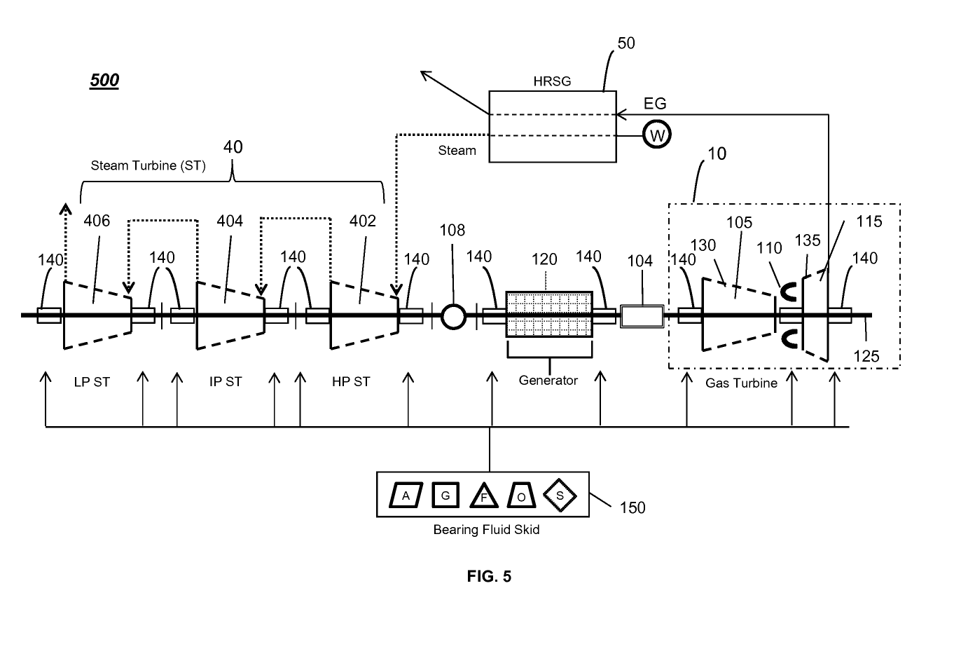

One representative load coupling element 104 is illustrated in FIG. 1 (between the gas turbine 10 and the generator 120), by way of example. Alternately, a clutch 108 may be used as the load coupling element, as shown in FIG. 5 (between the steam turbine 40 and the generator 120). In this manner, the respective rotor shaft parts that are coupled to the coupling members are rotatable thereto by respective bearings 140.

The compressor section 105 can include multiple stages of blades 130 disposed in an axial direction along rotor shaft 125. For example, the compressor section 105 can include forward stages of blades 130, mid stages of blades 130, and aft stages of blades 130. As used herein, the forward stages of blades 130 are situated at the front or forward end of the compressor section 105 along the rotor shaft 125 at the portion where airflow (or gas flow) enters the compressor via inlet guide vanes. The mid and aft stages of blades are the blades disposed downstream of the forward stages along the rotor shaft 125 where the airflow (or gas flow) is further compressed to an increased pressure. Accordingly, the length of the blades 130 in the compressor section 105 decreases from forward to mid to aft stages.

Each of the stages in the compressor section 105 can include rotating blades 130 arranged in a circumferential array about the circumference of the rotor shaft 125 to define moving blade rows extending radially outward from the rotatable shaft. The moving blade rows are disposed axially along rotor shaft 125 in locations that are situated in the forward stages, the mid stages, and the aft stages. In addition, each of the stages can include a corresponding number of annular rows of stationary vanes (not illustrated) extending radially inward towards rotor shaft 125 in the forward stages, the mid stages, and the aft stages. In one embodiment, the annular rows of stationary vanes can be disposed on the compressor's casing (not illustrated) that surrounds the rotor shaft 125.

In each of the stages, the annular rows of stationary vanes can be arranged with the moving blade rows in an alternating pattern along an axial direction of the rotor shaft 125 parallel with its axis of rotation. A grouping of a row of stationary vanes and a row of moving blades defines an individual “stage” of the compressor 105. In this manner, the moving blades in each stage are cambered to apply work and to turn the flow, while the stationary vanes in each stage are cambered to turn the flow in a direction best suited to prepare it for the moving blades of the next stage. In one embodiment, the compressor section 105 can be a multi-stage axial compressor.

The turbine section 115 can also include stages of blades 135 disposed in an axial direction along rotor shaft 125. For example, the turbine section 115 can include forward stages of blades 135, mid stages of blades 135, and aft stages of blades 135. The forward stages of blades 135 are situated at the front or forward end of the turbine section 115 along rotor shaft 125 at the portion where a hot compressed motive gas, also known as a working fluid, enters the turbine section 115 from the combustor section 110 for expansion. The mid and aft stages of blades are the blades disposed downstream of the forward stages along the rotor shaft 125 where the working fluid is further expanded. Accordingly, the length of the blades 135 in the turbine section 115 increases from forward to mid to aft stages.

Each of the stages in the turbine section 115 can include rotating blades 135 arranged in a circumferential array about the circumference of the rotor shaft 125 to define moving blade rows extending radially outward from the rotatable shaft. Like the stages for the compressor section 105, the moving blade rows of the turbine section 115 are disposed axially along the rotor shaft 125 in locations that are situated in the forward stages, the mid stages, and the aft stages. In addition, each of the stages can include annular rows of stationary vanes extending radially inward towards the rotor shaft 125 in the forward stages, the mid stages, and the aft stages. In one embodiment, the annular rows of stationary vanes can be disposed on the turbine's casing (not illustrated) that surrounds the rotor shaft 125.

In each of the stages, the annular rows of stationary vanes can be arranged with the moving blade rows in an alternating pattern along an axial direction of the rotor shaft 125 parallel with its axis of rotation. A grouping of a row of stationary vanes and a row of moving blades defines an individual “stage” of the turbine section 115. In this manner, the moving blades in each stage are cambered to apply work and to turn the flow, while the stationary vanes in each stage are cambered to turn the flow in a direction best suited to prepare it for the moving blades of the next stage.

As described herein, at least one of the rotating components (e.g., blades 130 and 135) in one of the compressor section 105 and the turbine section 115 can be formed from a low-density material. Those skilled in the art will appreciate that the number and placement of rotating blades 130 and 135 that include a low-density material can vary by design and application of the power generating plant in which the gas turbine architecture operates. For example, some or all of rotating blades 130 and 135 of a particular section (i.e., compressor section 105 or turbine section 115) can include a low-density material. In instances where rotating blades 130 and 135 in one or more rows or stages are formed of a low-density material, then rotating blades 130 and 135 in other rows or stages may be formed from a high-density material.

Referring back to FIG. 1, the bearings 140 support the rotor shaft 125 along the power train. For example, a pair of bearings 140 can each support the turbine rotor shaft part, the compressor rotor shaft part, and the generator rotor shaft part of rotor shaft 125. In one embodiment, each pair of bearings 140 can support the turbine rotor shaft part, the compressor rotor shaft part, and the generator rotor shaft part at their respective opposite ends of rotor shaft 125. However, those skilled in the art will appreciate that the pair of bearings 140 can support the turbine rotor shaft part, the compressor rotor shaft part, and the generator rotor shaft part at other suitable points. Moreover, those skilled in the art will appreciate that each of the turbine rotor shaft part, the compressor rotor shaft part, and the generator rotor shaft part of rotor shaft 125 is not limited to support by a pair of bearings 140. The bearing 140 shown between the compressor section 105 and the turbine section 115 (that is, beneath the combustors 110) may be optional, in some configurations. In the various embodiments described herein, at least one of bearings 140 can include a mono-type low-loss bearing.

The bearings 140 include fluids supplied by a bearing fluid skid 150, which is illustrated in FIG. 1. The bearing fluid skid 150 is marked with the letters “A” (for air), “G” (for gas), “F” (for magnetic flux), “S” (for steam), and “O” (for oil), although it should be understood that one or a combination of these fluids may be used to supply the multiple bearings 140 in the power train. In the present invention, an architecture having at least one bearing with a very low viscosity fluid is preferred. In these architectures, the bearings 140 are of a low-loss type—that is, bearings including a very low viscosity fluid, such as air, gas, magnetic flux, or steam, as described above.

The bearing fluid skid 150 may include equipment standard for bearing fluid skids, such as reservoirs, pumps, accumulators, valves, cables, control boxes, piping, and the like. The piping necessary to deliver the fluid(s) from the bearing fluid skid 150 to the one or more bearings 140 is represented in the Figures by arrows from the bearing fluid skid 150 to each of the bearings 140. In some instances, it may be possible for the bearing fluid skid 150 to provide two or more different types of fluids (such as oil and one or more of the low-viscosity fluids described above). Alternately, if two or more different bearing types are used, bearing skids 150 for each fluid type may be employed.

Those skilled in the art will appreciate that the selection of mono-type low-loss bearings used for bearings 140 can vary by design and application of the power generating plant in which the power train architecture operates. For example, some or all of bearings 140 can be mono-type low-loss bearings. In those sections where the rotor shaft part is supported by mono-type low-loss bearings, it may be preferred to incorporate low-density materials in the respective section to create a section whose weight is more easily supported and rotated.

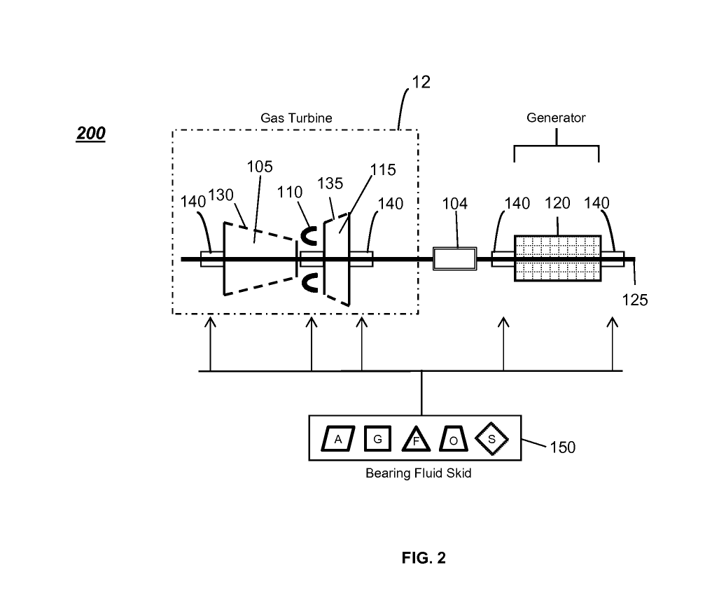

In addition, those skilled in the art will appreciate that, for clarity, the power train architecture shown in FIG. 1, and those illustrated in subsequent FIGS. 2-19, only show those components that provide an understanding of the various embodiments of the invention. Those skilled in the art will appreciate that there are additional components other than those that are shown in these figures. For example, a gas turbine and generator arrangement could include secondary components such as gas fuel circuits, a gas fuel skid, liquid fuel circuits, a liquid fuel skid, flow control valves, a cooling system, etc.

In a power train architecture such as those illustrated herein, which includes multiple bearings, the balance-of-plant (BoP) viscous losses are reduced in each location where a mono-type low-loss bearing is substituted for a conventional viscous fluid bearing. Thus, replacing multiple—if not all—of the viscous fluid bearings with low-loss bearings, as described, significantly reduces viscous losses, thereby increasing the efficiency of the power train at a base load of operation and a part load of operation.

The efficiency and power output of the power train architecture may be further improved by using rotating components of larger radial length. The challenge heretofore with producing rotating components of larger lengths has been that their weight makes them incompatible with low-loss bearings. However, the use of low-density materials for one or more of the rotating components permits the fabrication of components of the desired (longer) lengths without a corresponding increase in the airfoil pulls and rotor wheel diameter. As a result, a greater volume of air may be employed in producing motive fluid to drive the gas turbine, and low-loss bearings may be used to support the power train section in which the low-density rotating components are located.

Below are brief descriptions of the power train architectures illustrated in FIGS. 2-13. Specific gas turbine architectures, which may be employed in the power train architectures shown in FIGS. 1-13, are illustrated in FIGS. 14-19. All of these Figures illustrate different types of power trains that can be implemented in a power generating plant. Although each architecture may operate in a different manner than the configuration of FIG. 1, they are similar in that the embodiments in FIGS. 2-19 can have at least one low-density rotating component (e.g., the rotating blades 130 and 135 of compressor 105 and turbine 115, respectively). Similarly, these embodiments can use at least one mono-type low-loss bearing for bearings 140. As noted above, some or all of the rotating components 130 and 135 can be of a low-density material. With particular reference to blades in the compressor or turbine sections, rotating components of low-density material can be interspersed by stage with rotating components of high-density material. Likewise, some or all of the bearings 140 can be mono-type low-loss bearings. In this manner, bearings of a low-loss bearing type can be interspersed with other types of bearings such as oil bearings.

Further, the use of low-density rotating components and mono-type low-loss bearings in a power train of a power generating plant are not meant to be limited to the examples illustrated in FIGS. 1-19. Instead, these examples are merely illustrative of some of the possible architectures in which the use of low-density rotating components and mono-type low-loss bearings can be implemented in a power train of a power generating plant. Those skilled in the art will appreciate that there are many permutations of possible configurations of the examples illustrated herein. The scope and content of the various embodiments are meant to cover those possible permutations, as well as other possible power train configurations that can be implemented in a power generating plant that uses a gas turbine.

In addition, the descriptions that follow for the various architectures with their respective generator arrangements are directed to generators capable of being driven at various speeds (measured in revolutions-per-minute, or RPMs) to operate at a desired frequency output. It is not necessary that the turbine section directly drive the generator at 3600 RPMs in order to operate at 60 Hz, although such a speed and output may be desired for many applications. For instance, multi-shaft arrangements and/or torque-altering mechanisms (as in FIG. 19) may by employed to achieve the desired generator output. The various embodiments of the present invention are not meant to be limited to any particular type of generator and, therefore, are applicable to a wide variety of generators, including, but not limited to, two-pole generators that rotate at a speed of 3600 RPMs for operating at 60 Hz; four-pole generators that rotate at a speed of 1800 RPMs for operating at 60 Hz; two-pole generators that rotate at a speed of 3000 RPMs for operating at 50 Hz; and four-pole generators that rotate at a speed of 1500 RPMs for operating at 50 Hz. Other speeds and frequency outputs may be desired and appropriate for power train architectures producing less than 50 MW of power output.

FIG. 2 illustrates a simple cycle power train architecture 200 including a rear-end drive gas turbine 12, a generator 120, and a bearing fluid skid 150. In the architecture 200, the gas turbine 12 is arranged such that the generator 120 is coupled, via load coupling 104, to the turbine section 115 of the gas turbine, thus creating a “rear-end drive” gas turbine 12.

As with the architecture 100 shown in FIG. 1, the power train architecture 200 includes at least one mono-type low-loss bearing 140, which is in fluid communication with the bearing fluid skid 150. At least one rotating component (such as compressor blades 130 or turbine blades 135) is made of a low-density material, according to an embodiment of the present invention. Since the individual components of the architecture 200 are the same as those in the architecture 100, reference is made to the previous discussion of FIG. 1, and the discussion of each element is not repeated here.

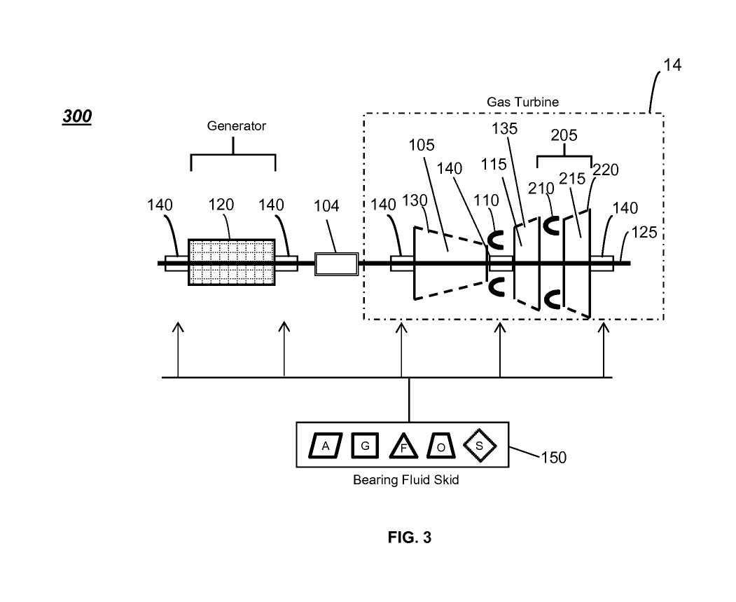

FIG. 3 is a schematic diagram of a power train architecture 300 having a front-end drive gas turbine 14 with a reheat section 205. As shown in FIG. 3, the reheat section 205 includes a second combustor section 210 and a second turbine section 215, also referred to as a reheat combustor and reheat turbine, respectively, downstream of the first combustor section 110 and the first turbine section 115. The power train architecture 300 includes at least one mono-type low-loss bearing 140, which is in fluid communication with the bearing fluid skid 150 (as described above).

In this embodiment, both the turbine section 115 and the turbine section 215 can have rotating components (such as blades 135, 220, respectively), which include at least one rotating component that includes a low-density material. In one embodiment, all or some of rotating blades 135 and/or 220 in one, some, or all of the turbine stages can include the low-density material. In another embodiment, the rotating components 130 in the compressor section 105 may include a low-density material. In another embodiment, at least one of the compressor section 105 and the turbine section 115 may include rotating components 130, 135 of a low-density material, while the rotating components 220 of the reheat turbine section 215 can be of a different type of material (e.g., a high-density material). If desired, each of the compressor section 105, the turbine section 115, and the reheat turbine 215 may include one or more stages of rotating components 130, 135, 220 of a low-density material. Other rotating components, including rotating components in the generator 120, may be used in addition to, or instead of, the rotating blades 130, 135, 220 described herein.

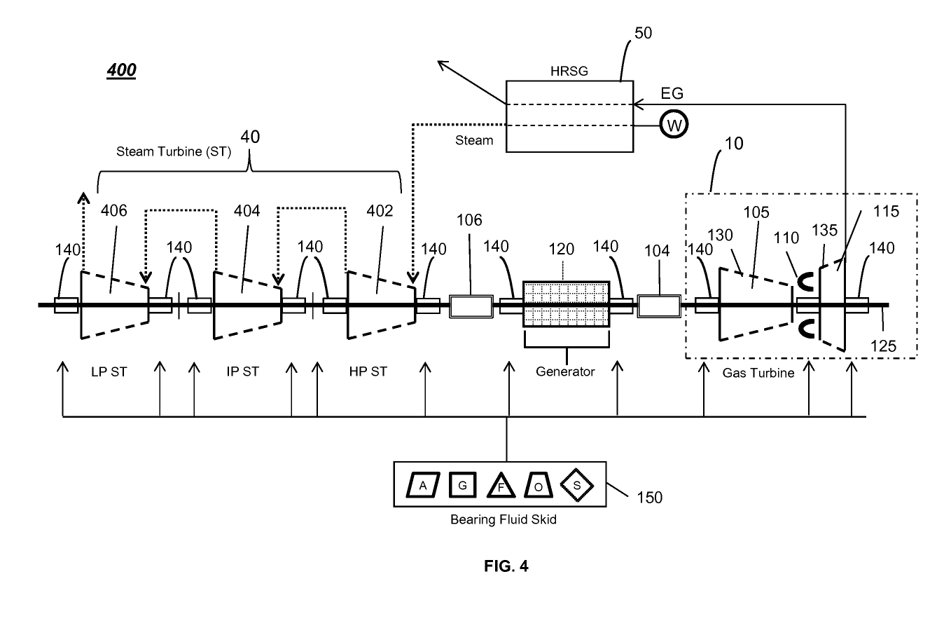

FIG. 4 is a schematic diagram of a single-shaft steam turbine and generator (STAG) power train architecture 400 including a front-end drive gas turbine 10, a multi-stage steam turbine 40, a generator 120, and a bearing fluid skid 150. A first load coupling 104 is positioned between the gas turbine 10 and the generator 120. The steam turbine 40 includes a high pressure (HP) section 402, an intermediate pressure (IP) section 404, and a low pressure (LP) section 406. Alternately, the steam turbine 40 may include a high pressure section 402 and a low (or lower) pressure section 406. Thus, the disclosure is not limited to a particular arrangement of the steam turbine 40. A second load coupling 106 connects the steam turbine 40 to the generator 120, thereby completing the unified shaft 125. Mono-type low-loss bearings 140 may be used to support any or all of the sections of the power train, the mono-type low-loss bearings 140 being fluidly connected to the bearing fluid skid 150.

Also shown in FIG. 4 is a heat exchanger, such as a heat recovery steam generator (or “HRSG”) 50. The HRSG 50 converts water (W) into steam that is supplied to the high pressure section 402 of the steam turbine 40, as indicated by dashed lines. The flow paths of the steam are indicated by dashed arrows, as steam is transferred sequentially from the high pressure section 402 to the intermediate pressure section 404 to the low pressure section 406 (or, in the case of a two-stage steam turbine, from the high pressure section to the low pressure section). Energy from a portion of the exhaust gases (“EG”) from the turbine section 115 of the gas turbine 10 is used to produce steam in the HRSG.

Low-density materials may be used for the rotating components of at least one of the compressor section 105 of the gas turbine 10, the turbine section 115 of the gas turbine 10, the high pressure section 402 of the steam turbine 40, the intermediate pressure section 404 of the steam turbine 40, the low pressure section 406 of the steam turbine 40, and the generator 120. The use of low-density materials (e.g., in blades 130, 135) reduces the weight of the stage, stages, or components being rotated, thus facilitating the use of low-loss bearings 140 for the corresponding section of the power train architecture 400.

FIG. 5 illustrates a power train architecture 500, which is a variation of the power train architecture 400 shown in FIG. 4. In FIG. 5, a single-shaft steam turbine and generator (STAG) is provided with a front-end drive gas turbine 10, a generator 120, a clutch 108, a multi-stage steam turbine 40, a heat exchanger 50, and a bearing fluid skid 150. In this architecture 500, the generator 120 is coupled, via load coupling 104, to the front end (i.e., compressor section 105) of the gas turbine 10 and is further coupled, via the clutch 108, to the steam turbine 40. Steam supplied from the heat exchanger 50 is directed to the high pressure section 402 of the steam turbine 40, the steam being subsequently routed through the intermediate pressure section 404 (when present) and the low pressure section 406 (as indicated by dashed arrows).

Low-density materials may be used for the rotating components of at least one of the compressor section 105 of the gas turbine 10 (e.g., in blades 130), the turbine section 115 of the gas turbine 10 (e.g., in blades 135), the high pressure section 402 of the steam turbine 40, the intermediate pressure section 404 of the steam turbine 40, the low pressure section 406 of the steam turbine 40, and the generator 120. Mono-type low-loss bearings 140 may be used to support those sections of the power train architecture 500, which include rotating components made of low-density materials. The mono-type low-loss bearings 140 are fluidly connected to the bearing fluid skid 150, as described previously.

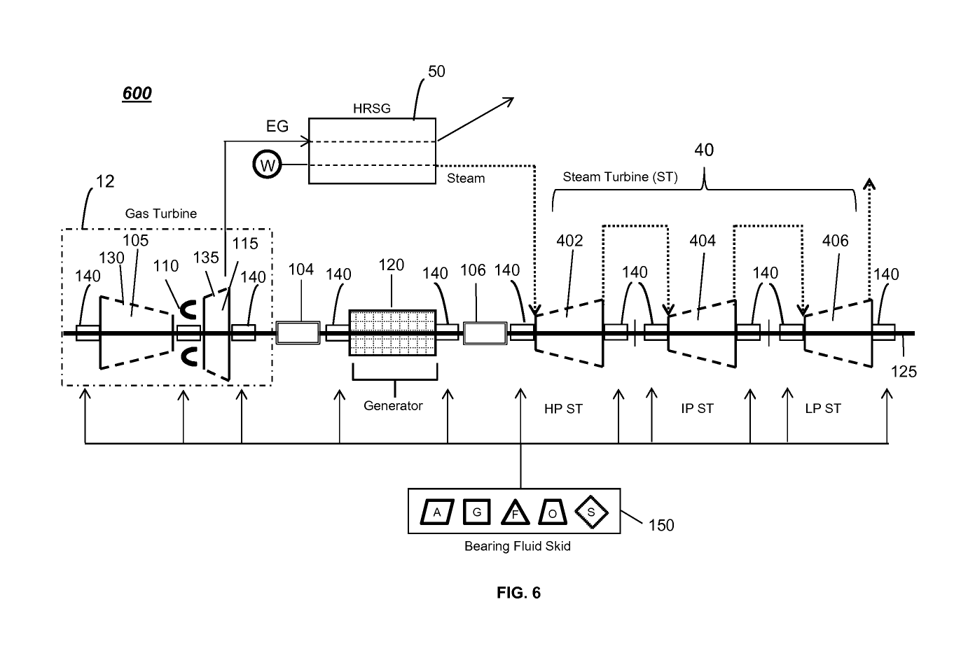

FIG. 6 illustrates a power train architecture 600, which is another alternate arrangement of the power train architecture 400 shown in FIG. 4. In FIG. 6, a single-shaft steam turbine and generator (STAG) is provided with a rear-end drive gas turbine 12, a generator 120, a multi-stage steam turbine 40, a heat exchanger 50, and a bearing fluid skid 150. In this architecture 600, the generator 120 is coupled, via a first load coupling 104, to the rear end (i.e., turbine section 115) of the gas turbine 12 and is further coupled, via a second load coupling 106, to the steam turbine 40. Steam supplied from the heat exchanger 50 is directed to the high pressure section 402 of the steam turbine 40, the steam being subsequently routed through the intermediate pressure section 404 (when present) and the low pressure section 406 (as indicated by dashed arrows).

Low-density materials may be used for the rotating components of at least one of the compressor section 105 of the gas turbine 12 (e.g., in blades 130), the turbine section 115 of the gas turbine 12 (e.g., in blades 135), the high pressure section 402 of the steam turbine 40, the intermediate pressure section 404 of the steam turbine 40, the low pressure section 406 of the steam turbine 40, and the generator 120. Mono-type low-loss bearings 140 may be used to support those sections of the power train architecture 600, which include rotating components made of low-density materials. The mono-type low-loss bearings 140 are fluidly connected to the bearing fluid skid 150, as described previously.

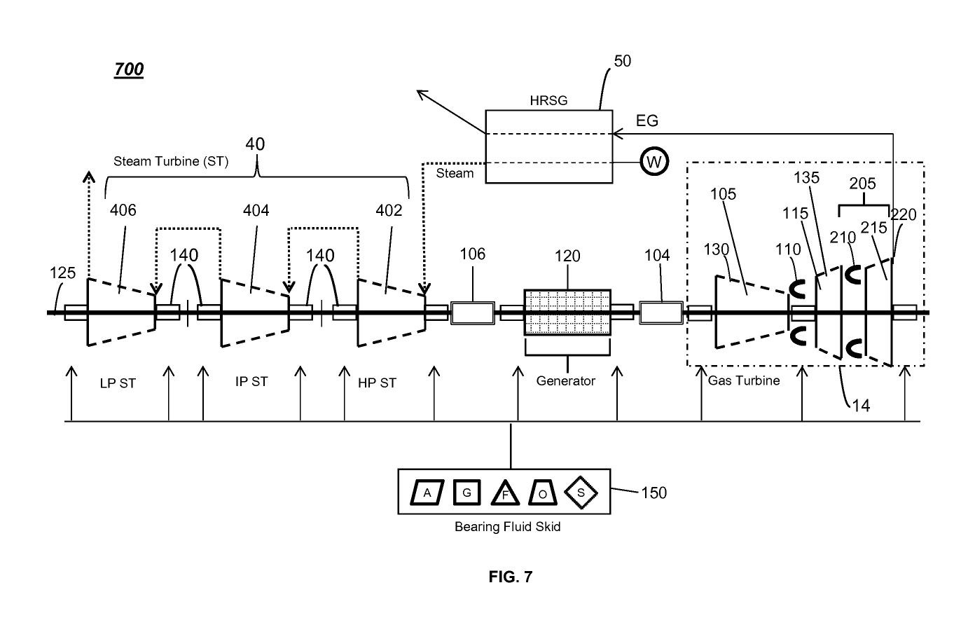

FIG. 7 illustrates a power train architecture 700, which is still another alternate arrangement of the power train architecture shown in FIG. 4. In FIG. 7, a single-shaft steam turbine and generator (STAG) is provided with a front-end drive gas turbine 14 with a reheat section 205, a generator 120, a multi-stage steam turbine 40, a heat exchanger 50, and a bearing fluid skid 150. In this arrangement, the generator 120 is coupled, via a first load coupling 104, to the front end (i.e., compressor section 105) of the gas turbine 14 and is further coupled, via a second load coupling 106, to the steam turbine 40. Steam supplied from the heat exchanger 50 is directed to the high pressure section 402 of the steam turbine 40, the steam being subsequently routed through the intermediate pressure section 404 (when present) and the low pressure section 406 (as indicated by dashed arrows).

Low-density materials may be used for the rotating components of at least one of the compressor section 105 of the gas turbine 14 (e.g., in blades 130), the turbine section 115 of the gas turbine 14 (e.g., in blades 135), the reheat turbine section 215 of the gas turbine 14 (e.g., in blades 220), the high pressure section 402 of the steam turbine 40, the intermediate pressure section 404 of the steam turbine 40, the low pressure section 406 of the steam turbine 40, and the generator 120. Mono-type low-loss bearings 140 may be used to support those sections of the power train architecture 700, which include rotating components made of low-density materials. The mono-type low-loss bearings 140 are fluidly connected to the bearing fluid skid 150, as described previously.

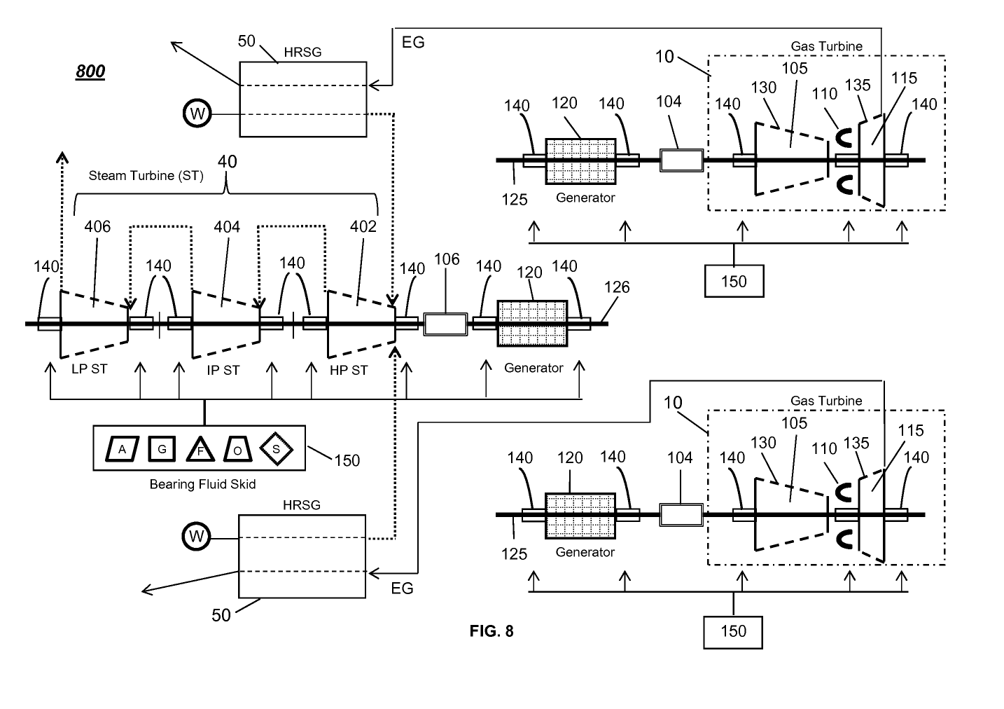

FIG. 8 is a schematic diagram of a two-on-one (2:1) combined cycle power train architecture 800 including two front-end drive gas turbines 10 (each with its own generator 120, heat exchanger 50, and bearing fluid skid 150) and one multi-stage steam turbine 40 with its own generator 120 and bearing fluid skid 150. As shown, the gas turbines 10 may be oriented in parallel to one another, although such configuration is not required.

In this architecture 800, each gas turbine 10 operates on its own shaft 125 and is coupled, via a first load coupling 104, to a generator 120. In one or both gas turbines 10, low-density materials may be used as the rotating components in the compressor section 105 (e.g., in blades 130) or the turbine section 115 (e.g., in blades 135) or in other areas (e.g., in the generator 120, as indicated by cross-hatching). The bearings 140 supporting the generator 120 and various sections of the gas turbine 10 may be mono-type low-loss bearings, as described herein. The bearings 140 are fluidly connected to the bearing fluid skid 150.

Exhaust products from the turbine section 115 of each gas turbine 10 are directed to a respective heat exchanger 50 (e.g., a HRSG), which produces steam for the high pressure section 402 of the steam turbine 40. Steam is subsequently routed through the intermediate pressure section 404 (when present) and the low pressure section 406 of the steam turbine 40 (as indicated by dashed arrows). The steam turbine 40 is coupled, via a shaft 126, to a corresponding generator 120. A load coupling 106 may be included between the steam turbine 40 and the generator 120.

Low-density materials may be used as the rotating components in the high pressure section 402 of the steam turbine 40, the intermediate pressure section 404 of the steam turbine 40, the low pressure section 406 of the steam turbine 40, or in other areas (e.g., in the generator 120 associated with the steam turbine 40). The bearings 140 supporting the generator 120 and various sections of the steam turbine 40 may be mono-type low-loss bearings, as described herein. The bearings 140 are fluidly connected to the bearing fluid skid 150 associated with the steam turbine 40.

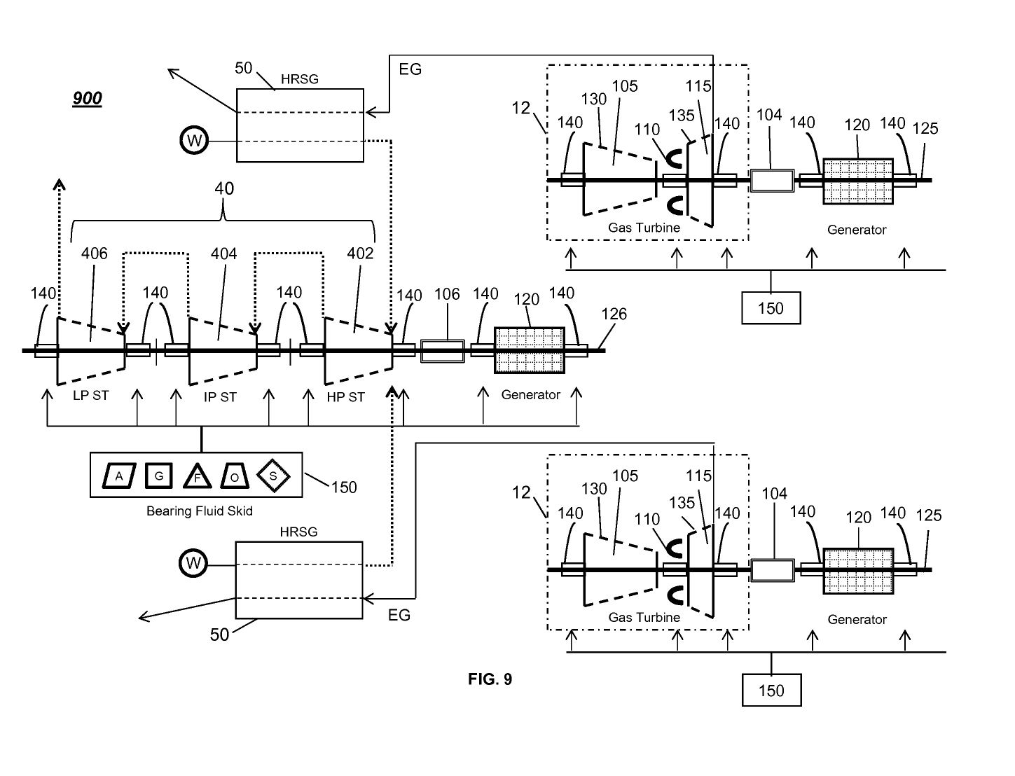

FIG. 9 is a schematic diagram of a two-on-one (2:1) combined cycle power train architecture 900 including two rear-end drive gas turbines 12 (each with its own generator 120, heat exchanger 50, and bearing fluid skid 150) and one multi-stage steam turbine 40 with its own generator 120 and bearing fluid skid 150. As shown, the gas turbines 12 may be oriented in parallel to one another, although such configuration is not required.

In this architecture 900, each gas turbine 12 operates on its own shaft 125 and is coupled, via a first load coupling 104, to a generator 120. In one or both gas turbines 12, low-density materials may be used as the rotating components in the compressor section 105 (e.g., in blades 130) or the turbine section 115 (e.g., in blades 135) or in other areas (e.g., in the generator 120, as indicated by cross-hatching). The bearings 140 supporting the generator 120 and various sections of the gas turbine 10 may be mono-type low-loss bearings, as described herein. The bearings 140 are fluidly connected to the bearing fluid skid 150.

Exhaust products from the turbine section 115 of each gas turbine 12 are directed to a respective heat exchanger 50 (e.g., a HRSG), which produces steam for the high pressure section 402 of the steam turbine 40. Steam is subsequently routed through the intermediate pressure section 404 (when present) and the low pressure section 406 of the steam turbine 40 (as indicated by dashed arrows). The steam turbine 40 is coupled, via a shaft 126, to a corresponding generator 120. A load coupling 106 may be included between the steam turbine 40 and the generator 120.

Low-density materials may be used as the rotating components in the high pressure section 402 of the steam turbine 40, the intermediate pressure section 404 of the steam turbine 40, the low pressure section 406 of the steam turbine 40, or in other areas (e.g., in the generator 120 associated with the steam turbine 40). The bearings 140 supporting the generator 120 and various sections of the steam turbine 40 may be mono-type low-loss bearings, as described herein. The bearings 140 are fluidly connected to the bearing fluid skid 150 associated with the steam turbine 40.

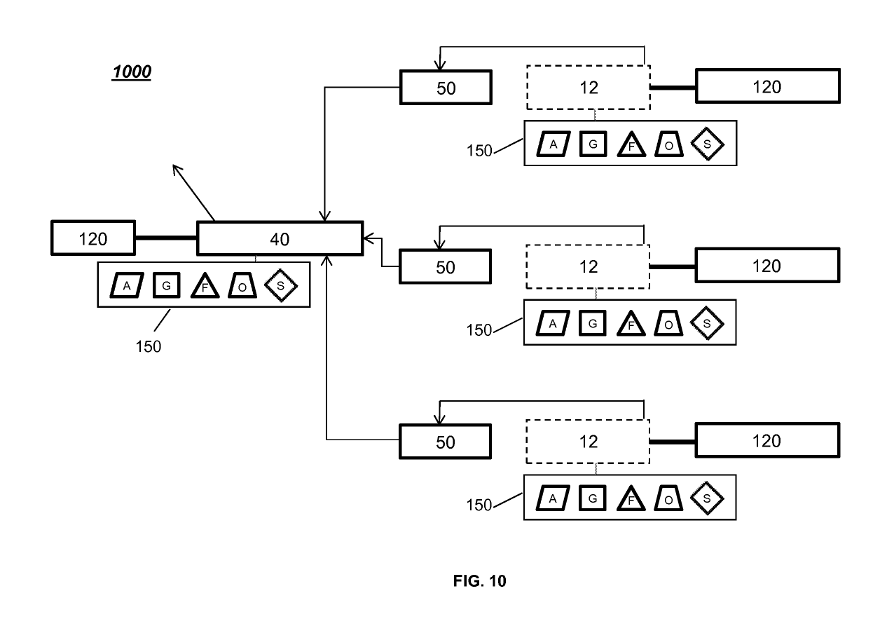

FIG. 10 is a simplified schematic diagram of a three-on-one (3:1) combined cycle power train architecture 1000, which includes three rear-end drive gas turbines 12 (each with its own generator 120, heat exchanger 50, and bearing fluid skid 150) and one multi-stage steam turbine 40 with its own generator 120 and bearing fluid skid 150. As discussed above, low-density materials may be used in the rotating components of at least one of the compressor section 105 of at least one gas turbine 12, the turbine section 115 of at least one gas turbine 12, the generator section 120 of at least one gas turbine 12, the high pressure section 402 of the steam turbine 40, the intermediate pressure section 404 (when present) of the steam turbine 40, the low pressure section 406 of the steam turbine 40, and the generator 120 associated with the steam turbine 40. Advantageously, for the reasons provided herein, those sections of the power train architecture 1000 that include the low-density materials in some or all of their rotating components are supported by mono-type low-loss bearings 140 (as illustrated in the previous Figures).

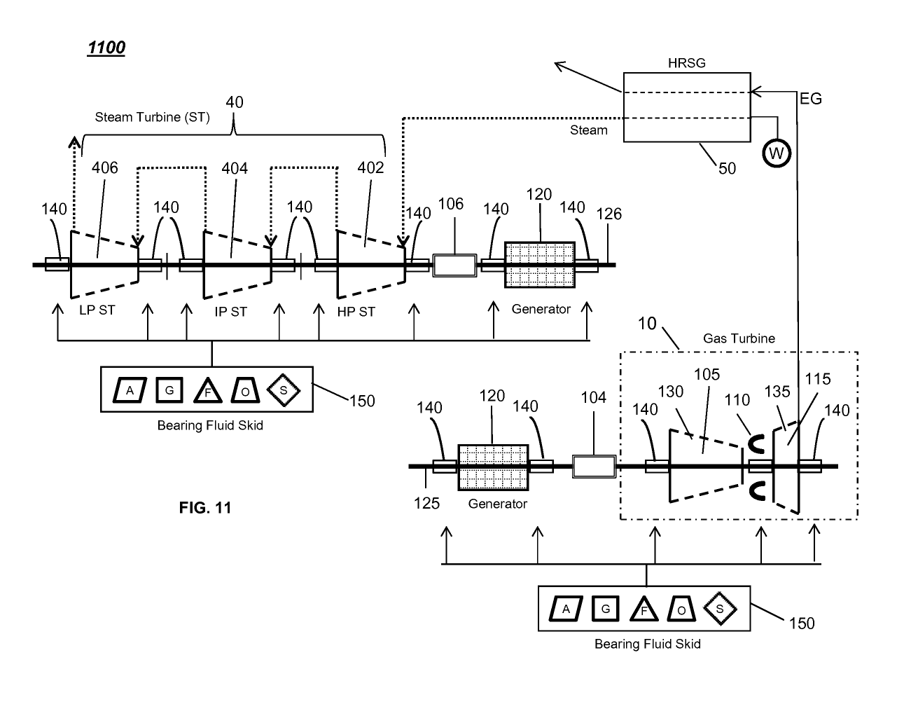

FIG. 11 is a schematic diagram of a multi-shaft, combined cycle power train architecture 1100, which includes a front-end drive gas turbine 10 coupled on a first shaft 125 to a first generator 120 and having a first bearing fluid skid 150. A first load coupling 104 may be used to connect the gas turbine 10 to the generator 120. The power train architecture 1100 further includes a multi-stage steam turbine 40 coupled on a second shaft 126 to a second generator 120 and having a second bearing fluid skid 150. A second load coupling 106 may be used to connect the steam turbine 40 to its corresponding generator 120. A heat exchanger 50 is fluidly connected to both the gas turbine 10 and the steam turbine 40, as previously discussed. In this architecture 1100, the steam from the heat exchanger 50 is provided to the high pressure section 402 of the steam turbine 40 and is subsequently routed through the intermediate pressure section 404 of the steam turbine 40 (when present) and the low pressure section 406 of the steam turbine 40.

Again, the rotating components in the compressor section 105 of the gas turbine 10, the turbine section 115 of the gas turbine 10, the generator 120 associated with the gas turbine 10, the high pressure section 402 of the steam turbine 40, the intermediate pressure section 404 of the steam turbine 40, the low pressure section 406 of the steam turbine 40, and/or the generator 120 associated with the steam turbine 40 may be produced from low-density materials. The low-density materials may be used to produce blades 130 in the compressor section 105 or blades 135 in the turbine section 115, for example.

The low-density material may be used for some or all of the rotating components in a given section of the power train architecture 1100. Those sections having rotating components made of low-density materials may be supported by low-loss bearings 140, which are fluidly coupled to a respective bearing fluid skid 150. Sections of the power train architecture 1100 including components of high-density materials may be supported by traditional viscous fluid (e.g., oil) bearings. The various embodiments of the present invention are not limited to any particular number or arrangement of mono-type low-loss bearings 140, regardless of the power train architecture being discussed.

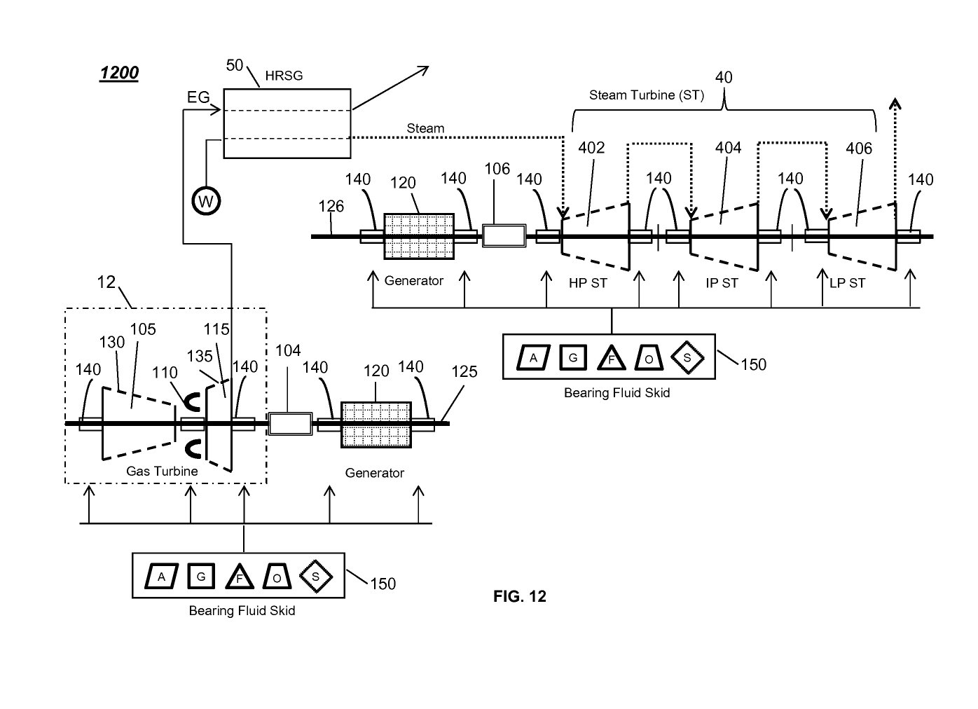

FIG. 12 is a schematic diagram of a multi-shaft, combined cycle power train architecture 1200, which is a variation of the architecture 1100 shown in FIG. 11. In FIG. 12, the architecture 1200 includes a rear-end drive gas turbine 12 coupled on a first shaft 125 to a first generator 120 and having a first bearing fluid skid 150. A first load coupling 104 may be used to connect the gas turbine 12 to the generator 120.

The power train architecture 1200 further includes a multi-stage steam turbine 40 coupled on a second shaft 126 to a second generator 120 and having a second bearing fluid skid 150. A second load coupling 106 may be used to connect the steam turbine 40 to its corresponding generator 120. A heat exchanger 50 is fluidly connected to both the gas turbine 12 and the steam turbine 40, as previously discussed. In this architecture 1200, the steam from the heat exchanger 50 is provided to the high pressure section 402 of the steam turbine 40 and is subsequently routed through the intermediate pressure section 404 of the steam turbine 40 (when present) and the low pressure section 406 of the steam turbine 40.

As before, the rotating components in the compressor section 105 of the gas turbine 12, the turbine section 115 of the gas turbine 12, the generator 120 associated with the gas turbine 12, the high pressure section 402 of the steam turbine 40, the intermediate pressure section 404 of the steam turbine 40, the low pressure section 406 of the steam turbine 40, and/or the generator 120 associated with the steam turbine 40 may be produced from low-density materials. The low-density materials may be used to produce blades 130 in the compressor section 105 or blades 135 in the turbine section 115, for example. The low-density material may be used for some or all of the rotating components in a given section of the power train architecture 1200. Those sections having rotating components made of low-density materials may be supported by mono-type low-loss bearings 140, which are fluidly coupled to a respective bearing fluid skid 150.

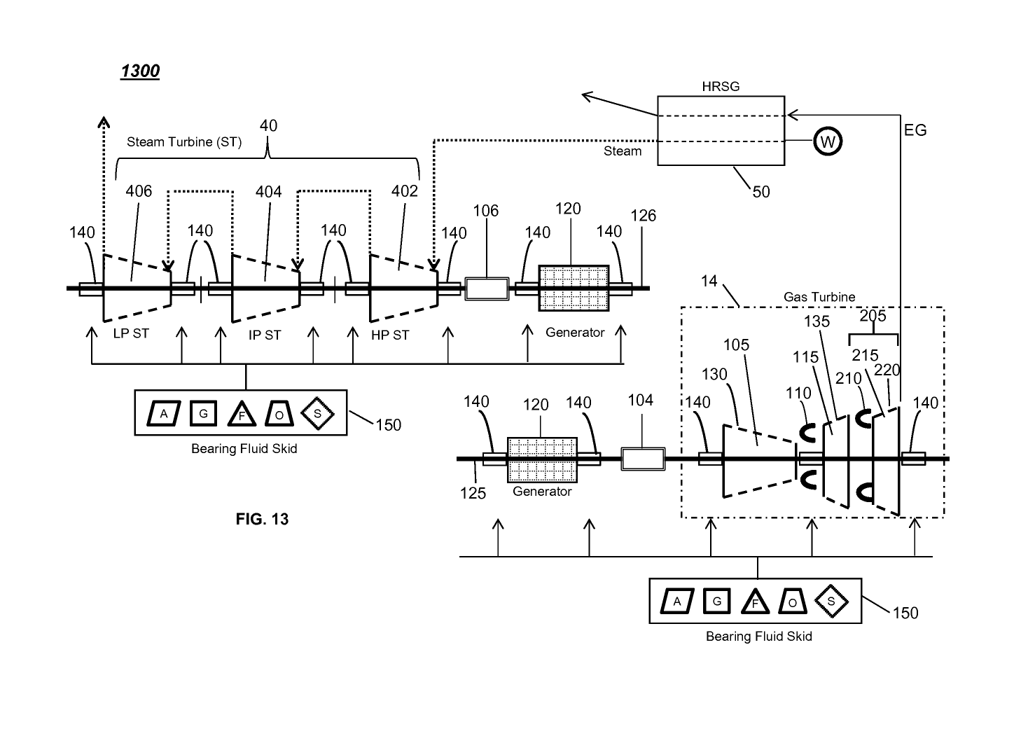

FIG. 13 is a schematic diagram of a multi-shaft, combined cycle power train architecture 1300, which is a variation of the architecture 1100 shown in FIG. 11. In FIG. 13, the architecture 1300 includes a front-end drive gas turbine 14 with a reheat section 205 coupled on a first shaft 125 to a first generator 120 and having a first bearing fluid skid 150. A first load coupling 104 may be used to connect the gas turbine 14 to the generator 120.

The power train architecture 1300 further includes a multi-stage steam turbine 40 coupled on a second shaft 126 to a second generator 120 and having a second bearing fluid skid 150. A second load coupling 106 may be used to connect the steam turbine 40 to its corresponding generator 120. A heat exchanger 50 is fluidly connected to both the gas turbine 14 and the steam turbine 40, as previously discussed. In this architecture 1300, the steam from the heat exchanger 50 is provided to the high pressure section 402 of the steam turbine 40 and is subsequently routed through the intermediate pressure section 404 of the steam turbine 40 (when present) and the low pressure section 406 of the steam turbine 40.

The rotating components in the compressor section 105 of the gas turbine 14, the turbine section 115 of the gas turbine 14, the reheat turbine section 215 of the gas turbine 14, the generator 120 associated with the gas turbine 14, the high pressure section 402 of the steam turbine 40, the intermediate pressure section 404 of the steam turbine 40, the low pressure section 406 of the steam turbine 40, and/or the generator 120 associated with the steam turbine 40 may be produced from low-density materials. The low-density materials may be used to produce blades 130 in the compressor section 105, blades 135 in the turbine section 115, or blades 220 in the reheat turbine section 215, for example. The low-density material may be used for some or all of the rotating components in a given section of the power train architecture 1100. Those sections having rotating components made of low-density materials may be supported by mono-type low-loss bearings 140, which are fluidly coupled to a respective bearing fluid skid 150.

FIGS. 14 through 19 illustrate various gas turbine architectures that may be incorporated into the power train architectures illustrated in FIGS. 1 through 13. For convenience, the generator 120, the bearing fluid skid 150, the heat exchanger 50, and the steam turbine 40 (if applicable) are omitted from this set of Figures.

FIG. 14 is a schematic diagram of a multi-shaft gas turbine architecture 1400, including a rear-end drive gas turbine 16 having a compressor section 105, a combustor section 110, and a turbine section 115 on a first shaft 310. The gas turbine 16 further includes a power turbine section 305 on a second shaft 315, which is downstream of the turbine section 115. The gas turbine 16 of FIG. 14 may be substituted for the gas turbine 12 in the power train architecture 200 of FIG. 2, the power train architecture 600 of FIG. 6, the power train architecture 900 of FIG. 9, the power train architecture 1000 of FIG. 10, and the power train architecture 1200 of FIG. 12.

In this embodiment, a rear-end drive arrangement is provided, in which the single shaft (as shown in the gas turbine 12 of FIG. 2) has been replaced with a multi-shaft arrangement. In particular, a first single rotor shaft 310 extends through the compressor section 105 and the turbine section 115, while a second single rotor shaft 315, separated from the shaft 310, extends from the power turbine section 305 to the generator 120 (not shown, but indicated by the legend “To Gen”).

In operation, the first rotor shaft 310 can serve as the input shaft, while the second rotor shaft 315 can serve as the output shaft. In one embodiment, the output speed of the rotor shaft 315 spins at a constant speed (e.g., 3600 RPMs) to ensure that the generator (120) operates at a constant frequency (e.g., 60 Hz), while the input speed of the rotor shaft 310 may be different than that of the rotor shaft 315 (e.g., may be greater than 3600 RPMs).

Bearings 140 can support the various gas turbine sections on the rotor shaft 310 and the rotor shaft 315. In one embodiment, at least one of the bearings 140 can include a mono-type low-loss bearing, as described herein. The bearings 140 are in fluid communication with the bearing fluid skid 150, as shown, for example, in FIG. 2.

In one embodiment, the power turbine 305 can have at least one rotating component 405 (e.g., a blade) that is made of a low-density material. FIG. 14 shows that the rotating blades 130 of the compressor section 105, the rotating blades 135 of the turbine section 115, and the rotating blades 405 of the power turbine section 305 can include one or more stages of low-density blades. This is one possible implementation and is not meant to limit the scope of architecture 1400. As mentioned above, there can be any combination of low-density blades with blades made from other materials (e.g., high-density blades), as long as there is at least one rotating blade used in the power train that includes a low-density material. Alternately or in addition, rotating components other than the blades 130, 135, 405 may be made from low-density material; thus, the disclosure is not limited to an arrangement where only the blades are made from low-density material. Preferably, the low-density rotating components 105, 135, and/or 405 are used in a section of the gas turbine 1400 that is supported by bearings 140 that are mono-type low-loss bearings.

FIG. 15 is a schematic diagram of a multi-shaft, rear-end drive gas turbine architecture 1500 having a gas turbine 18 with a power turbine section 305 and a reheat section 205. The gas turbine architecture 1500 further includes at least one mono-type low-loss bearing 140 and at least one rotating component made of a low-density material in use with the power train of the gas turbine, according to an embodiment of the present invention. As with FIG. 14, the gas turbine 18 of FIG. 15 may be substituted for the gas turbine 12 in the power train architecture 200 of FIG. 2, the power train architecture 600 of FIG. 6, the power train architecture 900 of FIG. 9, the power train architecture 1000 of FIG. 10, and the power train architecture 1200 of FIG. 12.

Gas turbine architecture 1500 is similar to the one illustrated in FIG. 14, except that the gas turbine 18 includes a reheat section 205 having a reheat combustor 210 and a reheat turbine 215. The reheat section 205 is added to the input drive shaft 310 of the gas turbine 18. FIG. 15 shows that the rotating components (e.g., blades) 130 of the compressor section 105, the rotating components (e.g., blades) 135 of turbine section 115, the rotating components (e.g. blades) 220 of the reheat turbine section 215, and the rotating components (e.g., blades) 405 of the power turbine section 305 can include low-density materials. This is one possible implementation and is not meant to limit the scope of architecture 1500. As mentioned above, there can be any combination of low-density components with components that include other materials (e.g., high-density materials), as long as there is at least one rotating component used in the power train that includes a low-density material. For greater efficiency, the section(s) of the architecture 1500 that are supported by mono-type low-loss bearings 140 include rotating components made of low-density material, wherein at least some of the rotating components are made of low-density material.

FIG. 16 is a schematic diagram of a front-end drive gas turbine architecture 1600 having a gas turbine 20 whose architecture includes a stub shaft 620 to reduce the rotating speed of forward stages 610 of a compressor 605. The gas turbine 20 further includes at least one mono-type low-loss bearing 140 in use with the power train of the gas turbine, according to an embodiment of the present invention. The gas turbine 20 of FIG. 16 may be substituted for the gas turbine 10 in those power train architectures having a front-end drive gas turbine, including the power train architecture 100 of FIG. 1, the power train architecture 400 of FIG. 4, the power train architecture 500 of FIG. 5, the power train architecture 800 of FIG. 8, and the power train architecture 1100 of FIG. 11.

In this embodiment, the compressor section 605 is illustrated with two stages 610 and 615, where stage 610 represents the forward stages of compressor 605 and stage 615 represents the mid and aft stages of compressor 605. This is only one configuration, and those skilled in the art will appreciate that compressor 605 could be illustrated with more stages. In any event, the rotating blades associated with stage 610 are coupled to a stub shaft 620, while the rotating blades of stage 615 and the turbine section 115 are coupled along the rotor shaft 125. In one embodiment, the stub shaft 620 can be radially outward from the rotor shaft 125 and circumferentially surround the rotor shaft 125. In one embodiment, at least one of the rotating components (e.g., blades 710, blades 715, and blades 135) are made of a low-density material.

Bearings 140 are located about the compressor section 605, the turbine section 115, and the generator 120 (not shown) to support the various sections on the stub shaft 620 and the rotor shaft 125. All, some, or at least one of the bearings in this configuration may be mono-type low-loss bearings, as described herein, such low-loss bearings 140 being particularly well-suited for supporting those sections of the architecture 1600 having rotating components made of low-density material.

In operation, the rotor shaft 125 enables the turbine section 115 to drive the generator 120 (shown in FIG. 1, for example). The stub shaft 620 can rotate at a slower operational speed than the rotor shaft 125, which causes the blades 710 of the forward stage 610 to rotate at a slower rotational speed than the blades 715 in the mid and aft stages of stage 615 (which are coupled to rotor shaft 125). In another embodiment, the stub shaft 620 can be used to rotate the blades 710 of stage 610 in a different direction than the blades 715 of stage 615. Having the blades 710 of stage 610 rotate at a slower rotational speed and/or in a different direction than the rotating blades 715 of stage 615 can enable stub shaft 620 to slow down the rotational speed of the forward stages of blades (e.g., to approximately 3000 RPMs), while rotor shaft 125 can maintain the rotational speed of the rotating blades 135 of the turbine section 115, and thus the speed of generator 120, to operate at a constant speed (e.g., 3600 RPMs).

Slowing down the rotational speed of the forward stages of blades 710 in stage 610 in relation to the mid and aft stages of the blades 715 in stage 615 facilitates the use of larger blades in the forward stages. As a result of their larger size, the airflow (or gas flow) through compressor 605 is increased over a conventional compressor, which means that more airflow will flow through gas turbine power train 1600. More airflow through gas turbine power train 1600 results in more output from the power train architecture.

Further, because the moving blades of the forward stages can operate at a reduced speed, attachment stresses that typically arise in these stages can be mitigated. As a result, if a compressor manufacturer desires to continue using blades of a high-density material in the forward stages, the slower rotational speed of the forward stage 610 permits the moving blades of the forward stages to be made in larger sizes and still remain within prescribed AN² limits. US patent application Ser. No. ______, entitled “MULTI-STAGE AXIAL COMPRESSOR ARRANGEMENT”, Attorney Docket No. 257269-1 (GEEN-0458), filed concurrently herewith and incorporated by reference herein, provides more details on the use of a stub shaft to attain a slower rotational speed at the forward stages of a compressor.

FIG. 17 is a schematic diagram of a gas turbine architecture 1700 having a front-end drive gas turbine 24 with a reheat section 205. The architecture 1700 further includes a stub shaft 620 to reduce the speed of forward stages of a compressor 605, at least one mono-type low-loss bearing 140, and at least one rotating component made of a low-density material, according to an embodiment of the present invention. In this embodiment, the reheat section 205 can be added to the configuration illustrated in FIG. 16. In this manner, the rotating blades 710 and 715 in stages 610 and 615, respectively, of compressor 605, the rotating blades 135 of the turbine 115, and the rotating blades 220 of the reheat turbine 215 can include blades that are made of a low-density material.

Again, this is one possible implementation and is not meant to limit the scope of architecture 1700. For example, there can be any number of low-density blades in combination with blades of other types of material (e.g., high-density blades) in the power train, as long as there is at least one rotating component made of a low-density material. Alternately, or in addition, rotating components other than the blades may be made of low-density materials in one or more sections. The gas turbine 24 of FIG. 17 may be substituted for the gas turbine 14 in those power train architectures having a gas turbine with a reheat section 205, including the power train architecture 300 of FIG. 3, the power train architecture 700 of FIG. 7, and the power train architecture 1300 of FIG. 13.

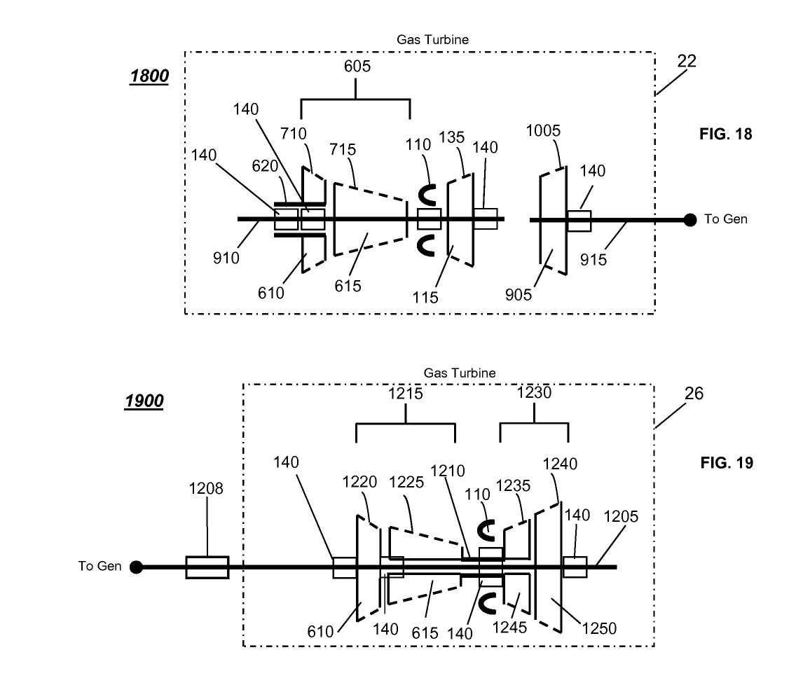

FIG. 18 is a schematic diagram of a gas turbine architecture 1800 having a rear-end drive gas turbine 22 whose architecture includes a stub shaft 620 to reduce the speed of forward stages of compressor 605, a power turbine 905, and at least one bearing 140 that is a mono-type low-loss bearing, according to an embodiment of the present invention. In this embodiment, a multi-shaft arrangement has been added to operate in conjunction with stub shaft 620. As shown in FIG. 18, a first single rotor shaft 910 extends through the compressor section 605 and the turbine section 115, while a second single rotor shaft 915, separated from rotor shaft 910 and stub shaft 620, extends from the power turbine section 905 to a generator 120 (as shown in FIG. 2). Bearings 140 can support the rotor shaft 910, the rotor shaft 915, and the stub shaft 620. In one embodiment, at least one of the bearings 140 can include a mono-type low-loss bearing.

In operation, the rotor shaft 910 and the stub shaft 620 can serve as the input shafts, while the rotor shaft 915 can serve as the output shaft that drives the generator 120. In one embodiment, the output speed of rotor shaft 915 is a constant speed (e.g., 3600 RPMs) to ensure that generator operates at a constant frequency (e.g., 60 Hz), while the input speed of the rotor shaft 910 and the stub shaft 620 is different from the speed at which the rotor shaft 915 operates (e.g., is less than the 3600 RPMs).

FIG. 18 shows that the rotating blades 710 and 715 of the compressor sections 610, 615, the rotating blades 135 of the turbine section 115, and the rotating blades 1005 of the power turbine section 905 can be made of low-density materials. This is one possible implementation and is not meant to limit the scope of architecture 1800. Again, there can be any combination of low-density rotating components (e.g., blades) in use with rotating components (e.g., blades) made of different compositions (e.g., high-density materials), as long as there is at least one rotating component used in the power train that includes a low-density material. In at least one embodiment, the low-density materials are used in rotating components in the section(s) of the gas turbine architecture 1800 supported by mono-type low-loss bearings 140.

FIG. 19 is a schematic diagram of a gas turbine architecture 1900 having a multi-shaft gas turbine 26 with a low-speed spool 1205 and a high-speed spool 1210. The gas turbine 26 further includes at least one mono-type low-loss bearing 140 in use with the power train of the gas turbine, according to an embodiment of the present invention. The gas turbine 26 of FIG. 19 may be substituted for the gas turbine 10 in those power train architectures having a front-end drive gas turbine, including the power train architecture 100 of FIG. 1, the power train architecture 400 of FIG. 4, the power train architecture 500 of FIG. 5, the power train architecture 800 of FIG. 8, and the power train architecture 1100 of FIG. 11.

In this embodiment, a compressor 1215 comprises a low pressure compressor 610 and a high pressure compressor 615 separated from low pressure compressor 610 by air. In addition, the gas turbine architecture 1900 comprises a turbine 1230 that comprises a low pressure turbine 1250 and a high pressure turbine 1245 separated from low pressure turbine 1250 by air. The low-speed spool 1205 can include the low pressure compressor 610, which is driven by the low pressure turbine 1250. The high-speed spool 1210 can include the high pressure compressor 615, which is driven by the high pressure turbine 1245. In this architecture 1900, the low-speed spool 1205 can drive the generator 120 at a desired rotational speed (e.g., 3600 RPMs) to operate at a desired frequency (e.g., 60 Hz), while the high-speed spool 1210 can operate at a rotational speed that is greater than that of the low-speed spool (e.g., greater than 3600 RPMs), forming a dual spool arrangement.

Optionally, a torque-altering mechanism 1208, such as a gearbox, torque-converter, gear set, or the like, may be positioned along the low speed spool 1205 between the gas turbine 26 and the generator (not shown, but indicated by “To Gen”). When a torque-altering mechanism 1208 is included, the torque-altering mechanism 1208 provides output correction, such that the low-speed spool 1205 can operate at a rotational speed greater than 3600 RPMs and drive the generator at a lower rotational speed of 3600 RPMs and still achieve an operating output of 60 Hz. In FIG. 19, at least one of the bearings 140 that support the power train 1900 can be a mono-type low-loss bearing. The bearings 140 are in fluid communication with the bearing fluid skid 150, as shown in FIG. 1, for example.

FIG. 19 shows that the rotating blades 1220 and 1225 of the compressor sections 610, 615 and the rotating blades 1235, 1240 of the turbine sections 1245,1250 can be made of low-density materials. This is one possible implementation and is not meant to limit the scope of architecture 1900. Again, there can be any combination of low-density rotating components (e.g., blades) in use with rotating components (e.g., blades) made of different compositions (e.g., high-density materials), as long as there is at least one rotating component used in the power train that includes a low-density material. In at least one embodiment, the low-density materials are used in rotating components in the section(s) of the gas turbine architecture 1900 supported by mono-type low-loss bearings 140.

As described herein, embodiments of the present invention describe various power train architectures with gas turbine architectures that can use mono-type low-loss bearings and low-density materials as part of a power train in a power generating plant. These gas turbine architectures with mono-type low-loss bearings and low-density materials can deliver a high airflow rate in comparison to other power trains that use oil bearings and high-density materials. In addition, this delivery of a higher airflow rate occurs while reducing viscous losses that are typically introduced into the power train through the use of oil-based bearings. An oil-free environment that arises from use of the mono-type low-loss bearings translates into a reduction in maintenance costs since components pertaining to the oil bearings can be removed.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises,” “comprising,” “includes,” “including,” and “having,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back” are not intended to be limiting and are intended to be interchangeable where appropriate.

While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the disclosure.

What is claimed is:

1. A power train architecture comprising:
a first gas turbine comprising a compressor section, a turbine section, and a combustor section operatively coupled to the compressor section and the turbine section;
a first rotor shaft extending through the compressor section and the turbine section of the first gas turbine;
a first generator, coupled to the first rotor shaft and driven by the turbine section of the first gas turbine; and
a plurality of bearings to support the first rotor shaft within the compressor section and the turbine section of the first gas turbine and the first generator, wherein at least one of the bearings is a mono-type low-loss bearing; and
wherein the compressor section of the first gas turbine, the turbine section of the first gas turbine, and the first generator include a plurality of rotating components, at least one of the rotating components in one of the compressor section of the first gas turbine, the turbine section of the first gas turbine, and the first generator including a low-density material.

2. The power train architecture of claim 1, wherein the first rotor shaft includes a single shaft arrangement having a compressor rotor shaft part and a turbine rotor shaft part.

3. The power train architecture of claim 1, wherein the first gas turbine comprises a rear-end drive gas turbine.

4. The power train architecture of claim 1, wherein the first gas turbine further comprises a reheat section operatively coupled to the turbine section along the first rotor shaft, the reheat section having a reheat combustor section and a reheat turbine section with a plurality of rotating components; and wherein at least one of the rotating components in the compressor section, the turbine section, the first generator, and the reheat turbine section includes the low-density material.

5. The power train architecture of claim 1, further comprising a steam turbine having a high pressure section and a low pressure section; and a first heat exchanger fluidly coupled to the first gas turbine and the steam turbine; wherein each of the high pressure section and the low pressure section comprises a plurality of rotating components; and wherein at least one of the rotating components in at least one of the compressor section of the first gas turbine, the turbine section of the first gas turbine, the first generator, the high pressure section of the steam turbine, and the low pressure section of the steam turbine includes the low-density material.

6. The power train architecture of claim 5, wherein the steam turbine comprises a plurality of bearings to support a steam turbine rotor shaft part within the high pressure section and the low pressure section, wherein at least one of the bearings is the mono-type low-loss bearing.

7. The power train architecture of claim 5, further comprising a load coupling element for coupling the steam turbine rotor shaft part of the steam turbine to the first gas turbine along the first rotor shaft.

8. The power train architecture of claim 5, further comprising a clutch located on the first rotor shaft between the steam turbine and the first gas turbine.

9. The power train architecture of claim 5, wherein the first gas turbine comprises a rear-end drive gas turbine.

10. The power train architecture of claim 5, wherein the first gas turbine further comprises a reheat section operatively coupled to the turbine section along the first rotor shaft, the reheat section having a reheat combustor section and a reheat turbine section with a plurality of rotating components; and wherein at least one of the rotating components in the compressor section, the turbine section, the first generator, the high pressure section of the steam turbine, the low pressure section of the steam turbine, and the reheat turbine section includes the low-density material.

11. The power train architecture of claim 5, further comprising a second rotor shaft, a second generator, and a steam turbine bearing fluid skid; wherein the steam turbine is coupled on the second rotor shaft to the second generator and the steam turbine bearing fluid skid is fluidly coupled to the steam turbine.

12. The power train architecture of claim 11, wherein the first gas turbine comprises a rear-end drive gas turbine.

13. The power train architecture of claim 11, wherein the first gas turbine further comprises a reheat section operatively coupled to the turbine section along the first rotor shaft, the reheat section having a reheat combustor section and a reheat turbine section with a plurality of rotating components; and wherein at least one of the rotating components in the compressor section, the turbine section, the first generator, the high pressure section of the steam turbine, the low pressure section of the steam turbine, the second generator, and the reheat turbine section includes the low-density material.

14. The power train architecture of claim 11, further comprising a third rotor shaft, a third generator, and a second gas turbine; wherein the second gas turbine is coupled on the third rotor shaft to the third generator.

15. The power train architecture of claim 14, further comprising a second heat exchanger fluidly coupled to the second gas turbine and the steam turbine, and wherein each of the first and second gas turbines is fluidly coupled to a separate gas turbine bearing fluid skid.

16. The power train system of claim 15, further comprising a fourth rotor shaft, a fourth generator, and a third gas turbine; wherein the third gas turbine is coupled on the fourth rotor shaft to the fourth generator.

17. The power train system of claim 16, further comprising a third heat exchanger fluidly coupled to the third gas turbine and the steam turbine; and wherein the third gas turbine is fluidly coupled to another gas turbine bearing fluid skid that is separate from ones coupled to the first gas turbine and the second gas turbine.

18. The power train architecture of claim 1, wherein the first gas turbine further comprises a power turbine section; wherein the first rotor shaft includes a multi-shaft arrangement having one rotor shaft extending through the compressor section and the turbine section and another rotor shaft extending through the power turbine section and the first generator, each of the rotor shafts supported by the plurality of bearings; and wherein the one rotor shaft is configured to operate at a rotational speed that is different from a rotational speed of the another rotor shaft which operates at a constant rotational speed.

19. The power train architecture of claim 18, wherein the power turbine section comprises a plurality of rotating components; and wherein at least one of the rotating components in the compressor section, the turbine section, the first generator, and the power turbine section includes the low-density material.

20. The power train architecture of claim 19, wherein the first gas turbine further comprises a reheat section operatively coupled to the turbine section along the one rotor shaft, the reheat section having a reheat combustor section and a reheat turbine section having a plurality of rotating components; and wherein at least one of the rotating components in the compressor section, the turbine section, the first generator, the power turbine section, and the reheat turbine section includes the low-density material.

21. The power train architecture of claim 18, wherein the compressor section of the first gas turbine includes forward stages distal to the combustor section, aft stages proximate to the combustor section, and mid stages disposed therebetween, each of the forward stages, the aft stages and the mid stages having a plurality of rotating components; wherein at least one of the rotating components in the forward stages of the compressor section, the mid stages of the compressor section, the aft stages of the compressor section, the turbine section, the first generator, and the power turbine section includes the low-density material; and wherein the first gas turbine comprises a stub shaft extending through the forward stages, the rotating components of the forward stages being arranged about the stub shaft to operate at a slower rotational speed than the rotating components of the mid and aft stages arranged about the rotor shaft.

22. The power train architecture of claim 21, wherein the plurality of bearings supports each of the one rotor shaft, the another rotor shaft, and the stub shaft, and at least one of the plurality of bearings supporting the one rotor shaft, the another rotor shaft, and the stub shaft is the mono-type low-loss bearing.

23. The power train architecture of claim 1, wherein the compressor section of the first gas turbine includes forward stages distal to the combustor section, aft stages proximate to the combustor section, and mid stages disposed therebetween, each of the forward stages, the aft stages and the mid stages having a plurality of rotating components; wherein at least one of the rotating components in the forward stages of the compressor section, the mid stages of the compressor section, the aft stages of the compressor section, the turbine section, and the first generator includes the low-density material; and wherein the first gas turbine further comprises a stub shaft extending through the forward stages, the rotating components of the forward stages being arranged about the stub shaft to operate at a slower rotational speed than the rotating components of the mid and aft stages arranged about the rotor shaft.

24. The power train architecture of claim 23, wherein the plurality of bearings includes stub shaft bearings to support the stub shaft, and at least one of the stub shaft bearings includes the mono-type low-loss bearing.

25. The power train architecture of claim 23, wherein the first gas turbine further comprises a reheat section operatively coupled to the turbine section along the first rotor shaft, the reheat section having a reheat combustor section and a reheat turbine section with a plurality of rotating components; and wherein at least one of the rotating components in the forward stages of the compressor section, the mid stages of the compressor section, the aft stages of the compressor section, the turbine section, the first generator, and the reheat turbine section includes the low-density material.

26. The power train architecture of claim 1, wherein the compressor section of the first gas turbine includes a low pressure compressor section and a high pressure compressor section, each having a plurality of rotating components; wherein the turbine section of the first gas turbine includes a low pressure turbine section and a high pressure turbine section, each having a plurality of rotating components; wherein the first rotor shaft includes a dual spool shaft arrangement having a low-speed spool and a high-speed spool; and wherein the high pressure turbine section drives the high pressure compressor section via the high-speed spool, and the low pressure turbine section drives the low pressure compressor section and the first generator via the low-speed spool.

27. The power train architecture of claim 26, wherein the low speed spool and the high speed spool are supported by the plurality of bearings, at least one of the bearings including the mono-type low-loss bearing.

28. The power train architecture of claim 27, wherein at least one of the rotating components in at least one of the low pressure compressor section, the high pressure compressor section, the low pressure turbine section, the high pressure turbine section, and the first generator includes the low-density material.
